(19) United States
(12) Patent Application Publication
(10) Pub. No.: US 2015/0009009 A1
(43) Pub. Date: Jan. 8, 2015

(54) CONDUCTIVE POLYMER FUSE

(71) Applicants: Ludwig Jenninger, Ahorn-Berolzheim (DE); Maria Jenninger, Ahorn-Berolzheim (DE)

(72) Inventors: Alireza Zarrabi, Sunnyvale, CA (US); Simon James Biggs, Los Gatos, CA (US); Werner Jenninger, Koln (DE)

(73) Assignee: Bayer Intellectual Property GmbH, Monheim (DE)

(21) Appl. No.: 14/009,124

(22) PCT Filed: Apr. 5, 2012
(86) PCT No.: PCT/US2012/032284

§ 371 Date: Jan. 29, 2014

Related U.S. Application Data
(60) Provisional application No. 61/472,783, filed on Apr. 7, 2011.

(51) Int. Cl. H01H 85/046; H01B 1/12; H01H 69/02

(52) U.S. Cl. CPC H01H 85/046; H01H 69/022; H01B 1/127; H01H 2229/004; H01H 2229/006
USPC 337/296; 29/623

(57) ABSTRACT

The present invention provides a conductive polymer fuse comprising a substrate having printed thereon poly(3,4-ethylenedioxythiophene)/poly(styrene-sulfonate) and one or more high conductivity connections, wherein the conductive fuse is encapsulated with an encapsulant. Methods for producing the inventive conductive polymer fuses are also provided. Such conductive polymer fuses may find use in improving printed electronic devices by protecting those devices against short circuits.

### CROSS REFERENCE TO RELATED APPLICATION

This application claims the benefit, under 35 USC §119(e), of U.S. provisional patent application No. 61/472,783 filed Apr. 7, 2011 entitled “CONDUCTIVE POLYMER FUSE”, the entire disclosure of which is hereby incorporated by reference.

### FIELD OF THE INVENTION

The present invention relates in general to printed electronics and more specifically to a conductive polymer fuse compatible with printed electronics which undergoes an irreversible chemical reaction at about 200° C.

### BACKGROUND OF THE INVENTION

Printed electronics require protection from short circuits just as conventional electronics do. Unfortunately, conventional fuses are based on melting or evaporation of a solid metal conductor. To melt, most metals require temperatures over 300° C., which are too high for most printed electronic substrates (polyester, polycarbonate, etc.). Even where low melting temperature alloys are used (e.g., containing tin, lead, indium, gallium, etc.), the difficulty of depositing and patterning the metal remains. Prior approaches to the problem (e.g., vacuum deposition, photolithography with a metal etchant), are unsatisfactory and can be undesirably expensive.

Thermal de-doping of the conductive polymer poly(3,4-ethylenedioxy-thiophene)/poly(styrene-sulfonate) (PEDOT:PSS) has been reported previously (See, Sven Moller-S, Perlov-C, A polymer/semiconductor write-once read-many-times (WORM) memory. Nature 426:166-169 (2003)), wherein the authors suggest using this phenomenon for storing data on a printed electronic circuit.

U.S. Published Patent Application No. 2002/0083858 in the name of MacDiarmid et al., provides a method of forming a pattern of a functional material on a substrate. One embodiment of a circuit element of the disclosure is a conductor polymer fuse, or sensor, shown in FIG. 19, which is said to comprise a conductive pattern prepared by patterning an aqueous suspension of poly(3,4-cthylenedioxy-thiophene)/poly(styrene-sulfonate), using toner ink patterns electrophotographically deposited by a laser printer onto a substrate in the manner described in Example 22. The behavior of this device is said to be dependent on the geometry and type of material used to construct the device. Applications of such a device are said to include electric stress sensors, e.g., for use in “classic” electronic assemblies, that detect the location of the circuitry breakdown, and use as fuses. MacDiarmid et al. do not address the location of the poly(3,4-ethylenedioxy-thiophene)/poly(styrene-sulfonate) fuse nor the material that makes the electrical and mechanical connection to the fuse. Finally, MacDiarmid et al. fail to disclose whether their fuses are encapsulated.

U.S. Pat. Nos. 6,157,528; 6,282,074; 6,388,856; 6,522,516; and 6,806,806 all issued to Anthony describe a polymer fuse apparatus that is said to provide bypass fuse protection. The polymer bypass fuse of Anthony is comprised of an electrical conductor wherein a portion of the conductor is surrounded by an internal electrode, which is then surrounded by a layer of polymeric positive temperature coefficient (PTC) material, which is then surrounded by a conductive material similar to that of the internal electrode. Various hybrid combinations are also contemplated by Anthony where in-line and/or bypass fuses are combined with other circuit components. An example given is a plurality of in-line and bypass fuses combined with a differential and common mode filter, which itself consists of a plurality of common ground conductive plates maintaining first and second electrode plates between the various conductive plates, all of which are surrounded by a material having predetermined electrical characteristics to provide fail safe filter and circuit protection.

U.S. Published Patent Application No. 2006/0019504 in the name of Taussig discloses a method for forming a plurality of thin-film devices. The method includes coarsely patterning at least one thin-film material on a flexible substrate and forming a plurality of thin-film elements on the flexible substrate with a self-aligned imprint lithography (SAIL) process. In the case where the switch layer is a conductive polymer fuse, Taussig states the switch layer may need to be protected by a non-organic barrier to prevent the switch layer from being etched away during the previous etch process. In this case, the non-organic barrier is etched away at this point in the process. This step is said to not be necessary if a metallic barrier layer is utilized in conjunction with a switch layer made of amorphous silicon.

### SUMMARY OF THE INVENTION

To circumvent difficulties encountered above, the present inventors disclose a conductive polymer fuse compatible with printed electronics. Unlike conventional fuses that require melting of a metal, this fuse undergoes an irreversible chemical reaction at about 200° C. The reaction destroys the electrical conductivity of the polymer, protecting the rest of the circuit. The conductive polymer fuse of the present invention comprises a substrate having printed thereon poly(3,4-ethylenedioxy-thiophene)/poly(styrene-sulfonate) (PEDOT:PSS) and one or more high conductivity connections, wherein the conductive polymer fuse is encapsulated with an encapsulant. Methods of making the inventive conductive polymer fuses are also provided. Such conductive fuses may find use in improving printed electronic devices by protecting those devices against short circuits.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 illustrates that using poly(3,4-ethylenedioxythiophene)/poly(styrene-sulfonate) as an electrode can be problematic;

FIG. 2 illustrates an electroactive polymer cartridge actuator segmented with conductive polymer fuses of the present invention;

FIG. 3 shows one embodiment of a roll electroactive polymer actuator segmented with conductive polymer fuses of the present invention;

FIG. 4 provides another embodiment of a roll electroactive polymer actuator segmented with conductive polymer fuses of the present invention;

FIG. 5 illustrates an embodiment of a trench-configuration with conductive polymer fuses of the present invention printed on rigid bars;

FIG. 6 shows a linear dielectric elastomer generator module for a 100 W generator including the conductive polymer fuses of the present invention;

FIG. 7 illustrates the profile of a good fuse;

FIGS. 8A and 8B show the parameters for adjusting the current limit of the conductive polymer fuses of the present invention (size, thickness, and electrode resistivity);

FIG. 9 shows the effects of adjusting the parameters of size, thickness, and electrode resistivity on the current limit of the conductive polymer fuses of the present invention;

FIG. 10 illustrates measurement of the properties of the conductive polymer fuses of the present invention;

FIG. 11 shows proof of concept with respect to range and repeatability of the conductive polymer fuses of the present invention;

FIG. 12A is a photograph showing the appearance of intact poly(3,4-ethylene-dioxythiophene)/poly(styrene-sulfonate) ink;

FIG. 12B is a photograph showing the appearance of oxidized poly(3,4-ethylenedioxythiophene)/poly(styrene-sulfonate) ink;

FIG. 13 illustrates an example of how high current makes poly(3,4-ethylene-dioxythiophene)/poly(styrene-sulfonate) resistive quickly;

FIG. 14 shows the surface resistance behavior of the conductive polymer fuses of the present invention coated at 100 m wet thickness on polyethylene terephthalate film;

FIG. 15 shows the conductivity behavior of the conductive polymer fuses of the present invention coated at 100 m wet thickness on polyethylene terephthalate film;

FIG. 16A is a diagram of a conductive polymer fuse;

FIG. 16B shows the thermal model of the conductive polymer fuse of FIG. 16A;

FIG. 17 shows the humidity and temperature stability of poly(3,4-ethylenedioxy-thiophene)/poly(styrene-sulfonate);

FIG. 18 shows conductive polymer fuse printing within print variation;

FIG. 19 illustrates whether fuse resistance accounts for differences in trip current;

FIG. 20 shows whether a conductive polymer fuse of the present invention works if it covered by polydimethylsiloxane (PDMS);

FIG. 21 illustrates whether connection to poly(3,4-ethylenedioxythiophene)/poly(styrene-sulfonate) affects trip current;

FIG. 22 shows the thermal and electrical properties of poly(3,4-ethylenedioxy-thiophene)/poly(styrene-sulfonate) screen-printing ink in air;

FIG. 23 illustrates the state change in poly(3,4-ethylenedioxythiophene)/poly(styrene-sulfonate) screen-printing ink;

FIG. 24 shows a plot of resistivity versus temperature for poly(3,4-ethylenedioxythiophene)/poly(styrene-sulfonate) screen-printing ink;

FIG. 25 illustrates the rate of thermal degradation of poly(3,4-ethylenedioxy-thiophene)/poly(styrene-sulfonate) screen-printing ink;

FIG. 26 shows the temperature coefficient in State 1 from FIG. 23;

FIG. 27 illustrates why poly(3,4-ethylenedioxythiophene)/poly(styrene-sulfonate) has desirable properties for a fuse;

FIG. 28 shows resistance repeatability for the conductive polymer fuses of the present invention;

FIG. 29 presents the results from a first printing of poly(3,4-ethylenedioxy-thiophene)/poly(styrene-sulfonate) fuses—DC (i,t) characteristic, and target;

FIG. 30A shows adjusting the thickness/of the conductive polymer fuse of the present invention with liquid filler;

FIG. 30B shows adjusting the surface resistance of the conductive polymer fuse of the present invention with liquid filler;

FIG. 31 illustrates dilution: effect on resistivity of poly(3,4-ethylenedioxy-thiophene)/poly(styrene-sulfonate) screen-printing ink;

FIG. 32 shows a typical cross section of 40 μm wet stencil;

FIG. 33 illustrates conductive polymer fuses of the present invention on polyurethane under oil;

FIG. 34 shows the energy needed to start clearing of a poly(3,4-ethylenedioxy-thiophene)/poly(styrene-sulfonate) fuse;

FIG. 35 shows the effect of an interface on the energy needed to start clearing of a poly(3,4-ethylenedioxythiophene)/poly(styrene-sulfonate) fuse;

FIG. 36 illustrates ˜90% of the thermal energy is missing;

FIG. 37 shows that heat transfer from fuse to film and air accounts for missing 90% of heat energy;

FIGS. 38A and 38B illustrate diluting poly(3,4-ethylenedioxythiophene)/poly(styrene-sulfonate) screen-printing ink with adhesion promoter (binder);

FIG. 39 shows adjusting resistivity with oxidizers;

FIG. 40 illustrates screen-printing conductive polymer fuses on different substrates;

FIGS. 41A and 41B show wetting out of screen-printing conductive ink on polydimethylsiloxane (PDMS);

FIG. 42 illustrates printing uniformity;

FIG. 43 shows printing conditions to vary conductive polymer fuse resistance;

FIG. 44 illustrates volatile methylsiloxane diluent to vary conductive polymer fuse resistance; and

FIG. 45 shows favorable length and width for poly(3,4-ethylenedioxy-thiophene)/poly(styrene-sulfonate) fuses.

### DETAILED DESCRIPTION OF THE INVENTION

Before explaining the disclosed embodiments in detail, it should be noted that the disclosed embodiments are not limited in application or use to the details of construction and arrangement of parts illustrated in the accompanying drawings and description. The disclosed embodiments may be implemented or incorporated in other embodiments, variations and modifications, and may be practiced or carried out in various ways. Further, unless otherwise indicated, the terms and expressions employed herein have been chosen for the purpose of describing the illustrative embodiments for the convenience of the reader and are not for the purpose of limitation thereof. Further, it should be understood that any one or more of the disclosed embodiments, expressions of embodiments, and examples can be combined with any one or more of the other disclosed embodiments, expressions of embodiments, and examples, without limitation. Thus, the combination of an element disclosed in one embodiment and an element disclosed in another embodiment is considered to be within the scope of the present disclosure and appended claims.

The present invention provides a conductive polymer fuse comprising a substrate having printed thereon poly(3,4-ethylenedioxythiophene)/poly(styrene-sulfonate) (PEDOT:PSS) and one or more high conductivity connections, wherein the conductive polymer fuse is encapsulated with an encapsulant.

The present invention further provides a method of making a conductive polymer fuse involving printing a solution or a suspension of poly(3,4-ethylenedioxy-thiophene)/poly(styrene-sulfonate) (PEDOT:PSS) on a substrate, connecting the poly(3,4-ethylenedioxythiophene)/poly(styrene-sulfonate) via one or more high conductivity connections to an electrical bus, and encapsulating the conductive polymer fuse with an encapsulant.

The present invention yet further provides a method of protecting an electronic device from a short circuit comprising including in the device one or more conductive polymer fuses made by printing a solution or a suspension of poly(3,4-ethylenedioxy-thiophene)/poly(styrene-sulfonate) (PEDOT:PSS) on a substrate, connecting the poly(3,4-ethylenedioxythiophene)/poly(styrene-sulfonate) via one or more high conductivity connections to an electrical bus and encapsulating the conductive polymer fuse with an encapsulant.

The conductive polymer fuses of the present invention may find particular applicability in providing protection to electroactive polymer devices. Examples of electroactive polymer devices and their applications are described, for example, in U.S. Pat. Nos. 7,394,282; 7,378,783; 7,368,862; 7,362,032; 7,320,457; 7,259,503; 7,233,097; 7,224,106; 7,211,937; 7,199,501; 7,166,953; 7,064,472; 7,062,055; 7,052,594; 7,049,732; 7,034,432; 6,940,221; 6,911,764; 6,891,317; 6,882,086; 6,876,135; 6,812,624; 6,809,462; 6,806,621; 6,781,284; 6,768,246; 6,707,236; 6,664,718; 6,628,040; 6,586,859; 6,583,533; 6,545,384; 6,543,110; 6,376,971; 6,343,129; 7,952,261; 7,911,761; 7,492,076; 7,761,981; 7,521,847; 7,608,989; 7,626,319; 7,915,789; 7,750,532; 7,436,099; 7,199,501; 7,521,840; 7,595,580; and 7,567,681, and in U.S. Patent Published Application Nos. 2009/0154053; 2008/0116764; 2007/0230222; 2007/0200457; 2010/0109486; and 2011/128239, and PCT Publication No. WO2010/054014, the entireties of which are incorporated herein by reference.

The inventive conductive polymer fuses may be used to protect segments of an electroactive polymer device such that a dielectric failure in one segment will result in increased current through one or more fuses connecting that segment to the power supply. The higher current is sufficient to “trip” the fuse or render it non-conductive to electrically isolate the failed segment with the electrical short from the other segments and enable continued operation of the undamaged segments.

Although the printing described herein in the context of the invention is screen printing, the present invention is not to be so limited. Other printing methods, including but not limited to, pad printing, ink jet printing, and aerosol jet printing may be useful in the practice of the present invention. The poly(3,4-ethylenedioxy-thiophene)/poly(styrene-sulfonate) (PEDOT:PSS) may be dissolved or suspended in a solvent system that comprises water. The high conductivity connections may comprise silver or carbon.

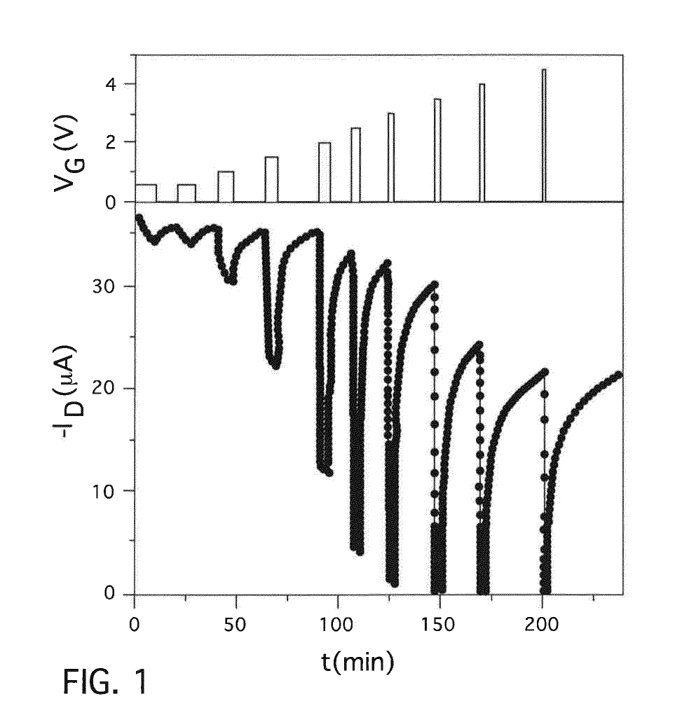

As shown in FIG. 1, (See, Fang-Chi Hsu, Vladimir N. Prigodin and Arthur J. Epstein. Electric-field-controlled conductance of “metallic” polymers in a transistor structure. Physical Review B 74, 235219 2006), poly(3,4-ethylenedioxy-thiophene)/poly(styrene-sulfonate) is problematic when used as an electrode. It loses lateral conductivity in strong, transverse electric fields such as those put across elastomeric dielectrics, such as an electroactive polymer actuator. To combat this phenomenon, the present inventors locate conductive fuses in passive regions of devices, where there is no transverse high-voltage electric field. Fuses overlying high-voltage regions quickly de-dope and become useless as shown in FIG. 1.

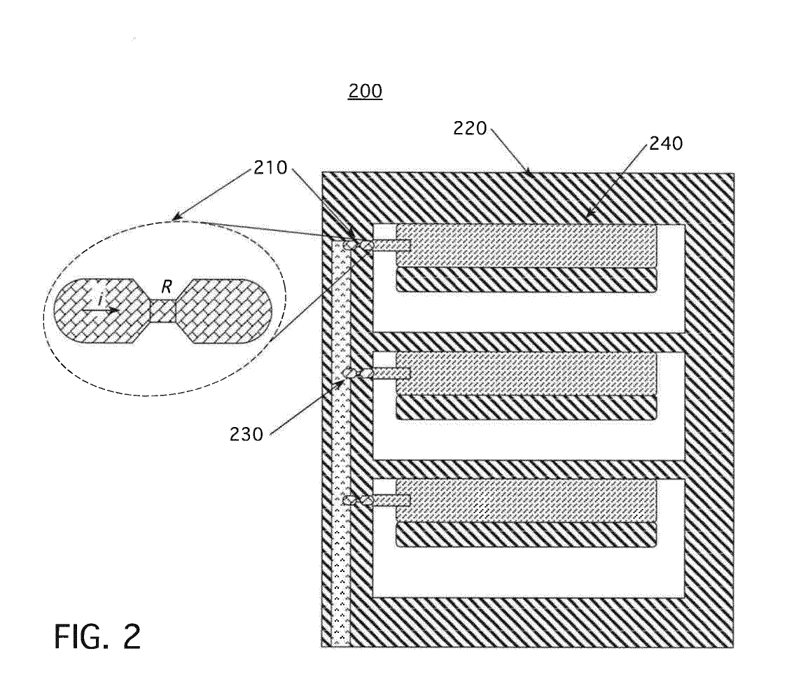

FIG. 2 illustrates an electroactive polymer cartridge transducer segmented with conductive polymer fuses of the present invention. As shown in FIG. 2, stiff frame 220 of the cartridge actuator 200 having electrodes 240 is connected to bus 230 by poly(3,4-ethylenedioxythiophene)/poly(styrene-sulfonate) fuses 210. The bus may be made of poly(3,4-ethylenedioxythiophene)/poly(styrene-sulfonate) or silver.

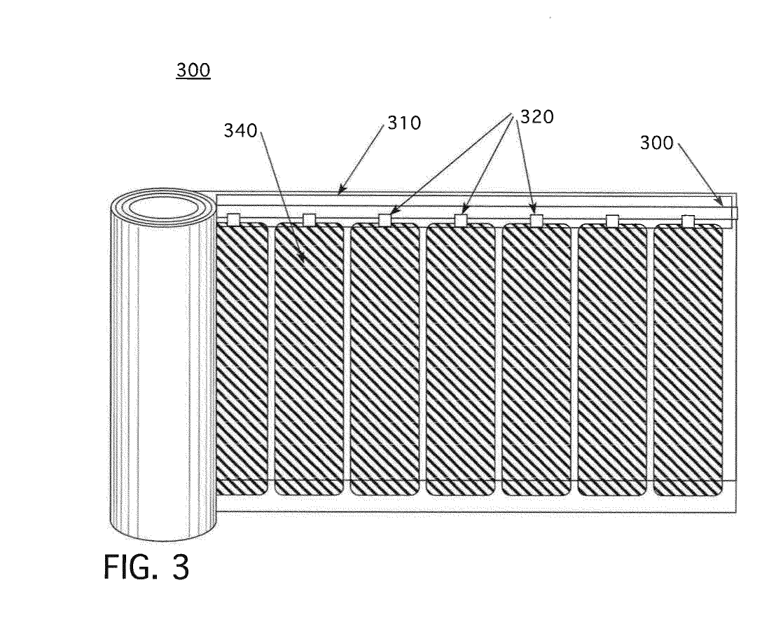

Another embodiment of a roll electroactive polymer transducer segmented with poly(3,4-ethylenedioxythiophene)/poly(styrene-sulfonate) fuses is provided in FIG. 3. Roll electroactive polymer actuator 300 contains stiffening strip 310, fuses 320 connecting electrodes 340 to bus 330. Encapsulation with an epoxy cap in this embodiment removes the requirement of a special elastic poly(3,4-ethylenedioxy-thiophene)/poly(styrene-sulfonate), reduces exposure to oxygen and water, and provides a repeatable thermal boundary condition.

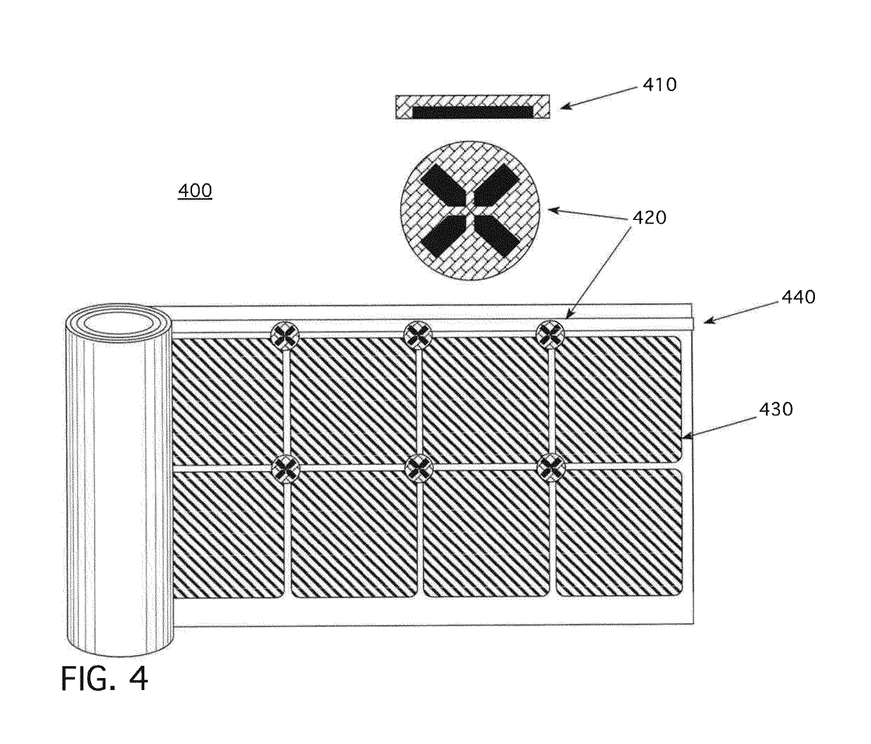

FIG. 4 provides another embodiment of a roll electroactive polymer actuator segmented with the inventive conductive polymer fuses. As shown if FIG. 4, the roll electroactive polymer actuator 400 comprises poly(3,4-ethylenedioxy-thiophene)/poly(styrene-sulfonate) fuses 420 connecting the electrical bus 440 to electrodes 430. The fuses 420 also connect the electrodes 430 to each other. In this embodiment, the conductive polymer fuses 420 have an epoxy cap 410. As in the previous embodiment, encapsulation with an epoxy cap also removes the requirement of a special elastic poly(3,4-ethylenedioxy-thiophene)/poly(styrene-sulfonate), reduces exposure to oxygen and water, and provides a repeatable thermal boundary condition.

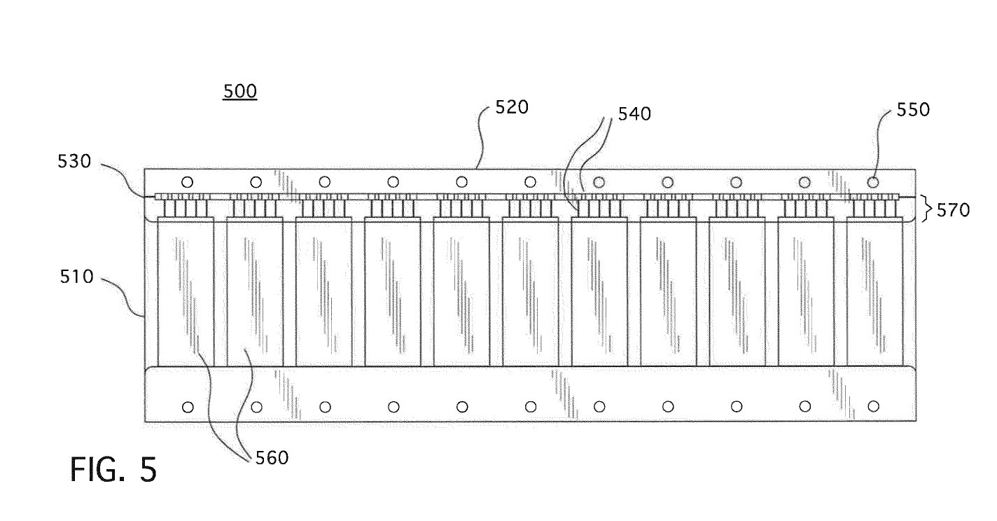

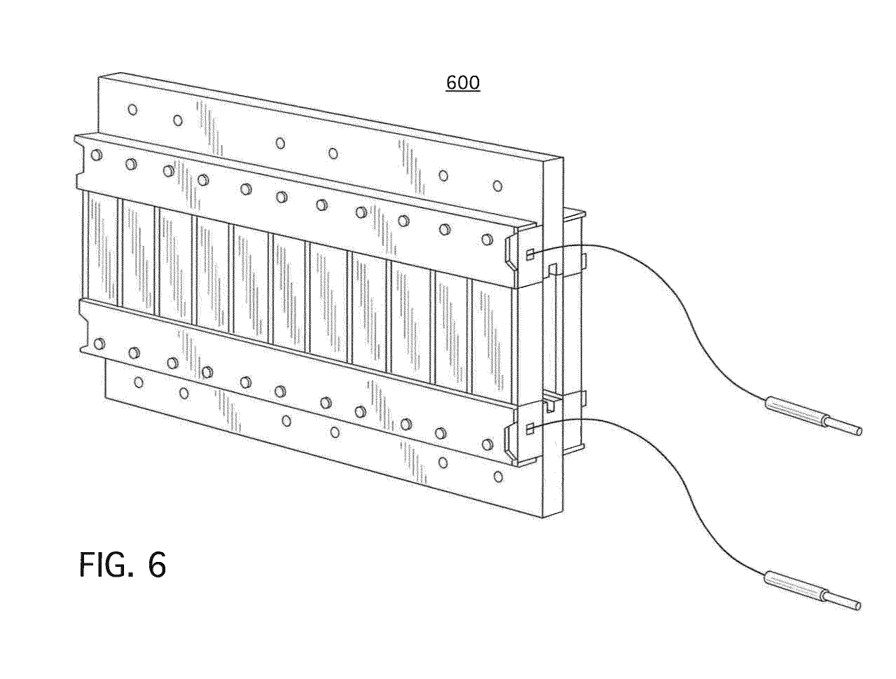

FIG. 5 illustrates an embodiment of a trench-configuration electroactive polymer transducer with conductive polymer fuses of the present invention printed on rigid bars. As shown in FIG. 5, electroactive polymer transducer 500 comprises elastomeric dielectric 510 and electrodes 560 connected to electric bus 530 by fuses 570. The electric bus in embodiment shown in FIG. 5 is copper plated end-to-end. Silver ink 540 is placed over the fuses 570. Mounting holes 550 are positioned in polycarbonate film 520 with soldermask. One application of such a trench-configuration transducer is shown in FIG. 6 wherein a linear dielectric generator module for 100 W generator includes the poly(3,4-ethylenedioxythiophene)/poly(styrene-sulfonate) fuses of the present invention. Examples of these generators may be found for example in co-assigned PCT patent application PCT/US12/28406 the entirety of which is incorporated herein by reference.

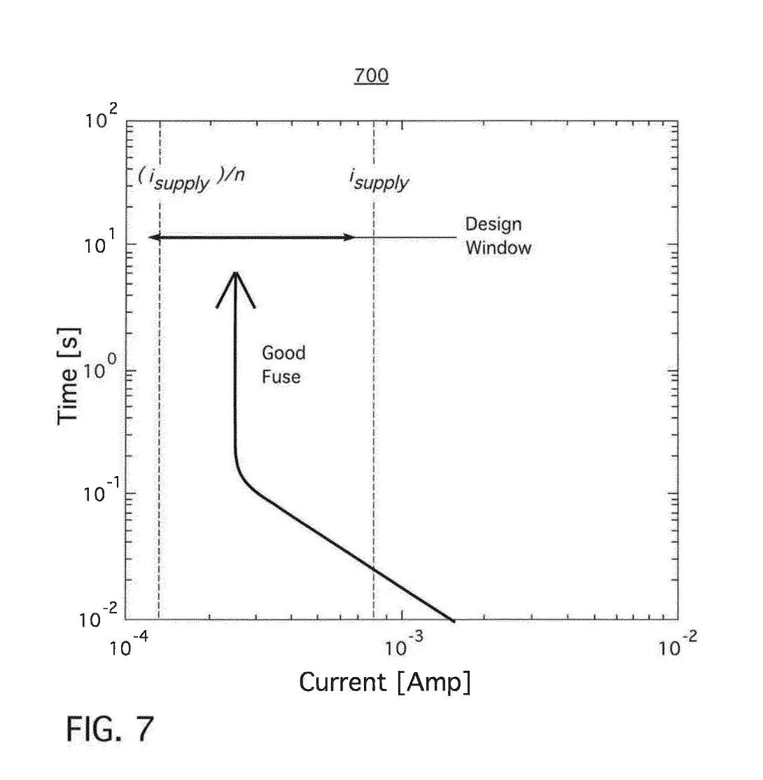

FIG. 7 illustrates the profile of a good fuse. As can be appreciated by reference to FIG. 7, a good fuse will blow when carrying the maximum current of the power supply (for example, i_{supply}=800 μA) and ensures correct operation if a fault is present at startup. A good fuse conducts when carrying one segment worth of power supply current (for example, a six bar electroactive polymer actuator has n=6 segments and i_{supply}/n=133 μA). Finally, a good fuse withstands the voltage of the power supply, for example V_{supply}=1000 Volt.

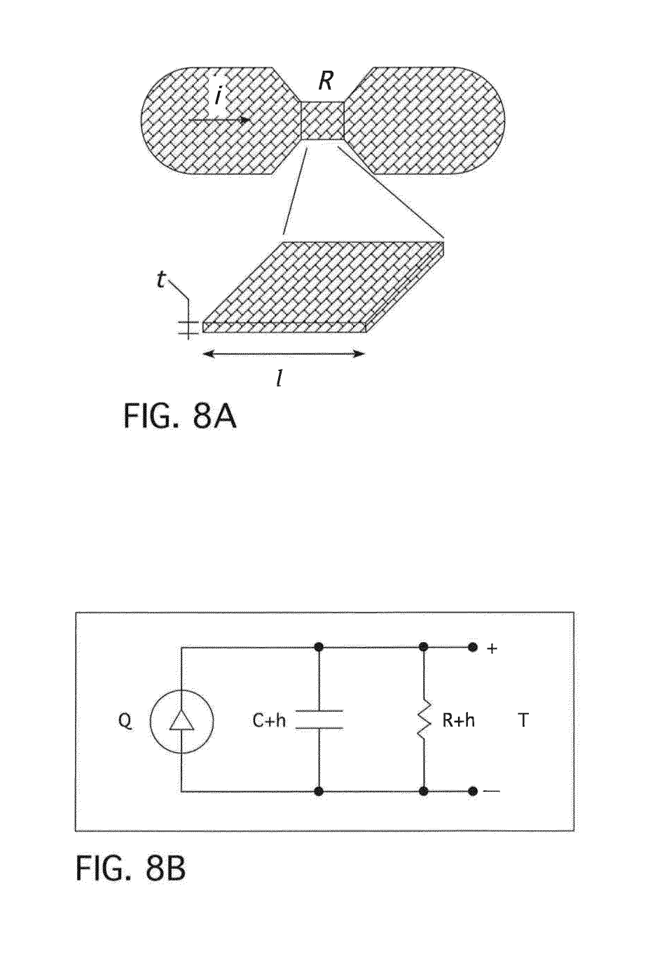

FIGS. 8A and 8B show how the current limit of the conductive polymer fuse of the present invention may be adjusted by size, thickness, and electrode resistivity.

The following equations describe this relationship

$$Electrical Resistance \text{?} = \frac{\text{?}}{t}$$

$$Heat input Q = \text{?} \text{?}$$

$$Thermal capacity \text{?} = \text{?} t \text{?}$$

$$Temperature change Δ T = Q \text{?} ( 1 - \text{?} )$$

$$Time to blow \text{?} = - \text{?} \text{?} log ( 1 - \frac{Δ T}{\text{?} \text{?} \text{?}} )$$

$$\text{?} \text{indicates text missing or illegible when filed}$$

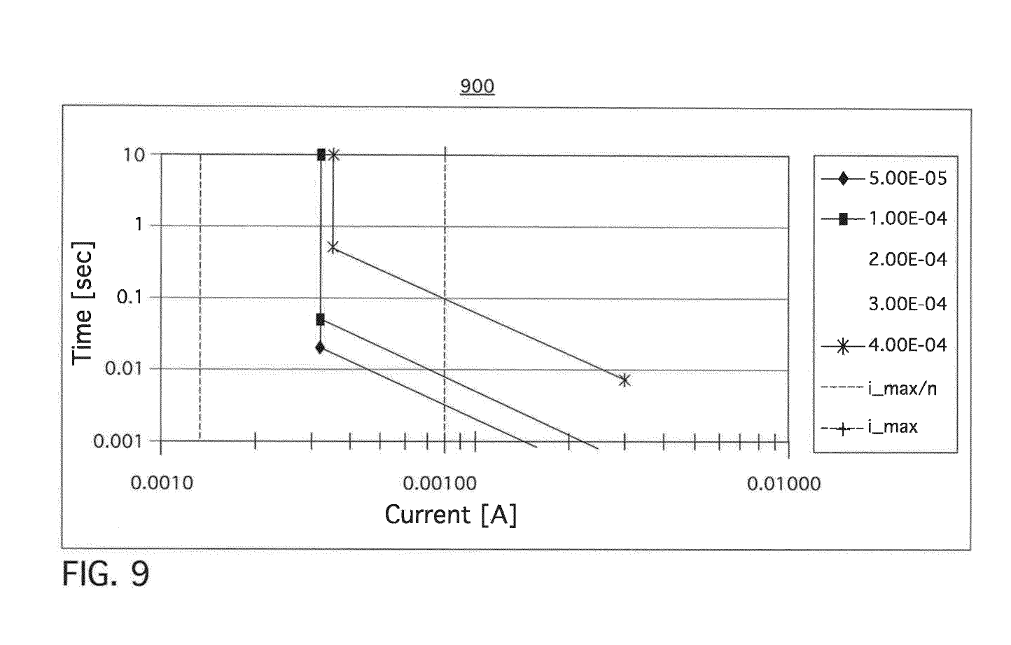

FIG. 9 provides a plot of time (see) versus current (A) to illustrate these effects

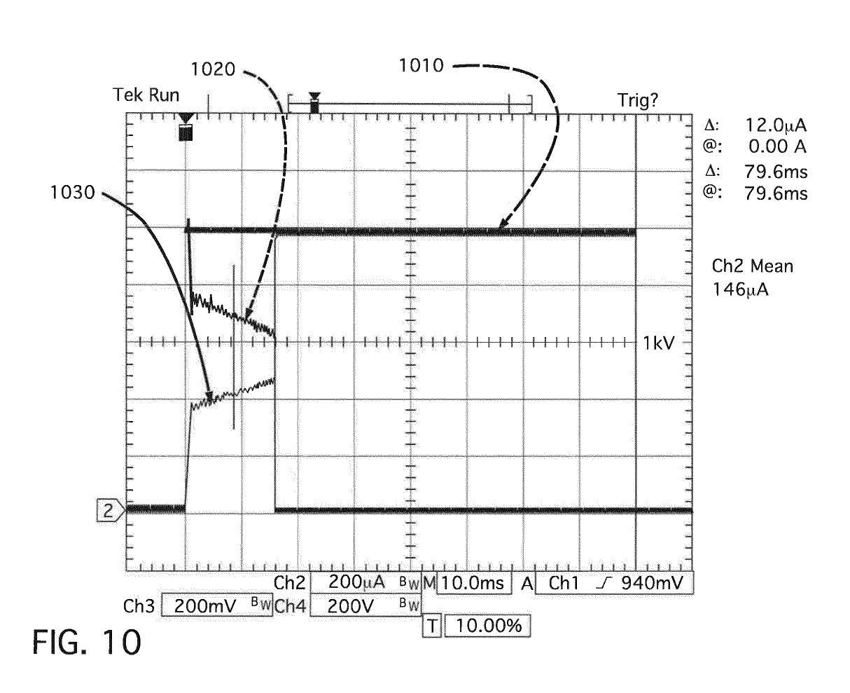

FIG. 10 illustrates the measurement of properties of the inventive conductive polymer fuse. 1010 refers to the commanded voltage, 1020 is the current through the fuse, and 1030 is the voltage across the fuse. As can be appreciated by reference to FIG. 10, over a 16-millisecond period the polymer fuse transitions successfully from conducting to insulating. During this period the current through it drops to essentially zero, and it holds off the applied voltage of 1000V, thereby protecting the device under test.

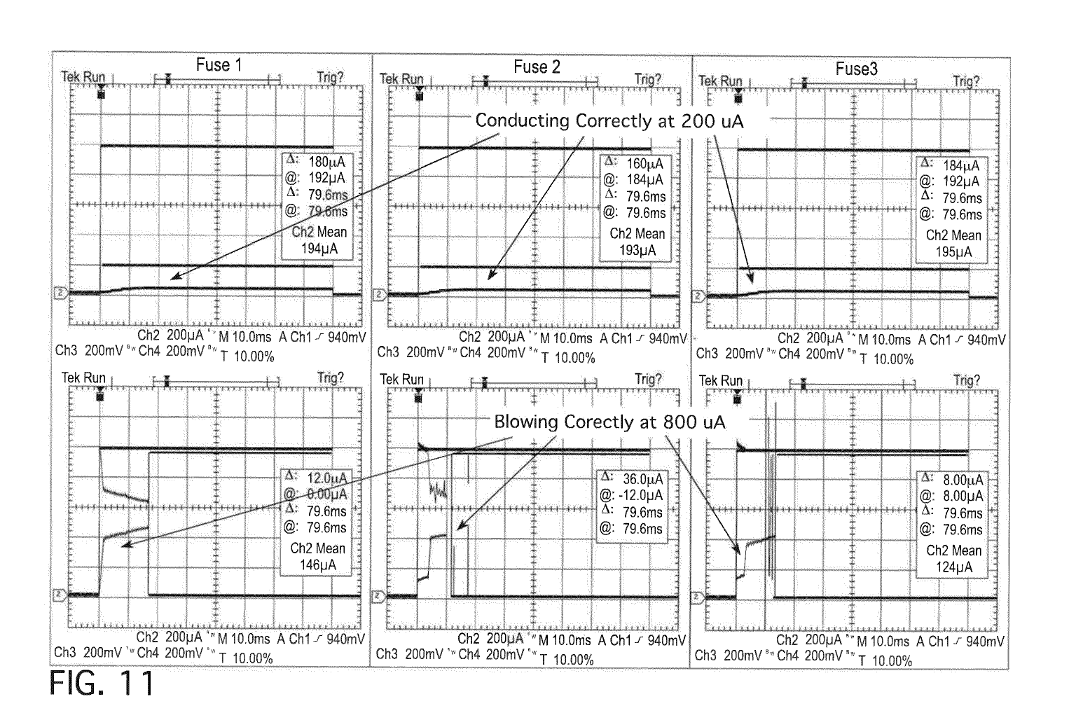

FIG. 11 shows a proof of the inventive concept with respect to range and repeatability. A poly(3,4-ethylenedioxythiophene)/poly(styrene-sulfonate) screen-printing ink (AGFA EL-P-3040) was printed on a proprietary dielectric elastomer film, in strips 300 μm wide, and tested at 1 kV. As can be appreciated by reference to FIG. 11, all three conductive polymer fuses conducted correctly at 200 μA and blew correctly at 800 μA.

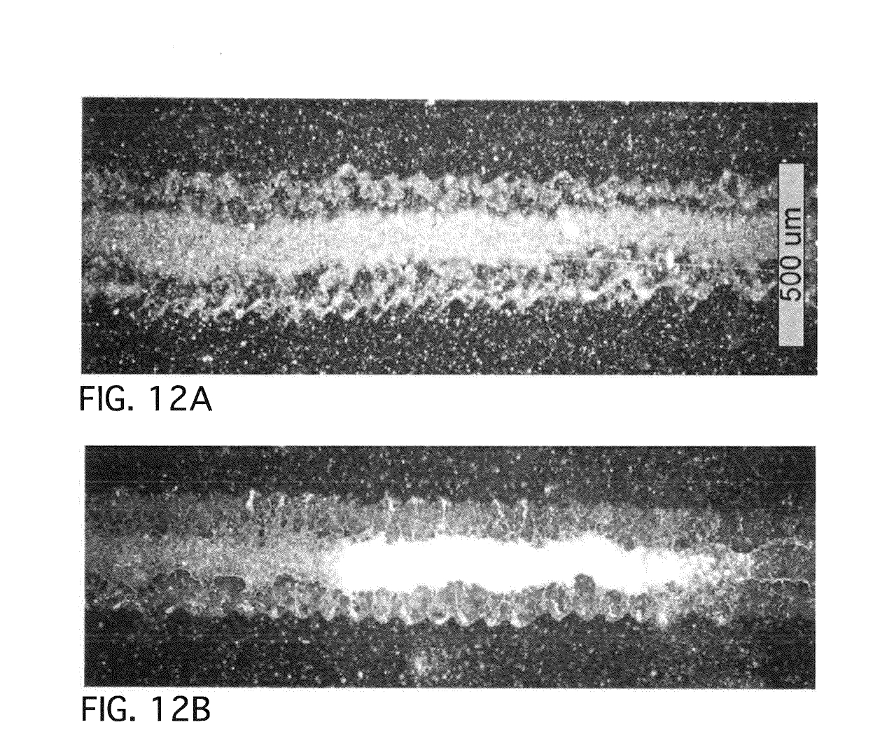

FIG. 12A is a photograph showing the appearance of intact poly(3,4-ethylene-dioxythiophene)/poly(styrene-sulfonate) ink and FIG. 12B is a photograph showing the appearance of oxidized poly(3,4-ethylenedioxythiophene)/poly(styrene-sulfonate) ink.

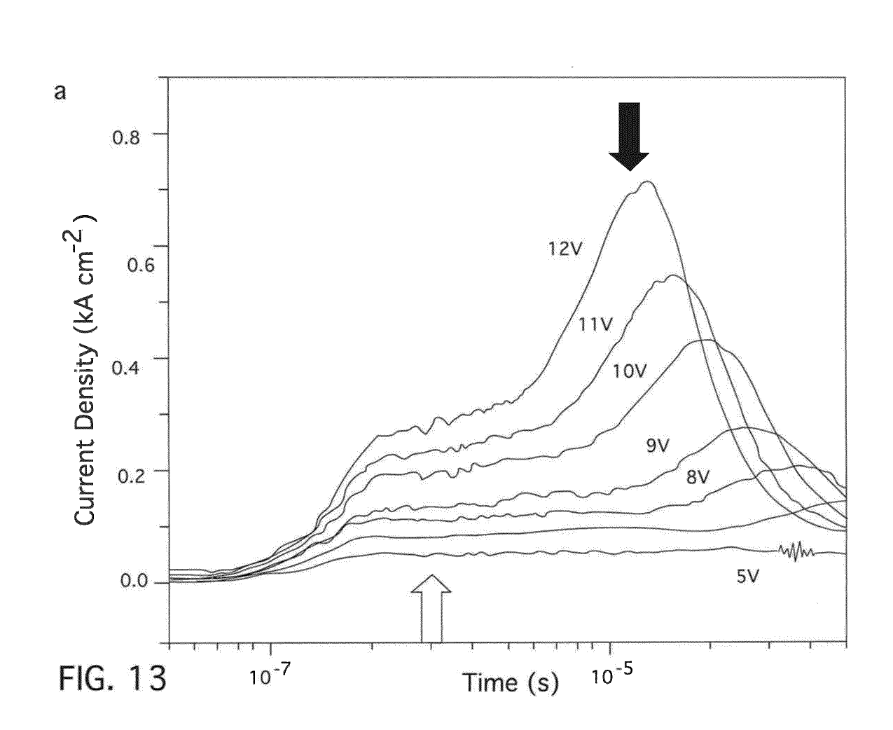

FIG. 13, reprinted from Sven Moller-S, Perlov-C, A polymer/semiconductor write-once read-many-times memory. Nature 426:166-169 (2003), illustrates how high current makes poly(3,4-ethylenedioxythiophene)/poly(styrene-sulfonate) resistive quickly. At yet higher voltages above V_{offset}<4.5 V, electron injection leads to the process that characterizes region B—a large, permanent decrease in film conductivity by up to a factor of 103. The magnitude and rapidity of the change to the low conductivity state depends on t and duty cycle, indicating that thermal effects contribute at high current densities. Permanent conductivity changes by thermal un-doping of the polymer at elevated temperatures have been previously reported (Sven Moller-S., et al, 2003). Calculations of the temperature rise during the current transients, based on the heat capacity and thermal conductivities typical of polymers, suggests the maximum temperatures of 200° C. required to initiate the un-doping process are reached at current densities of 1 kAcm² within the first 1 μs of the voltage pulse.

FIG. 13 shows the behavior of a “write once read many” (WORM) memory element under transient voltage pulse conditions. Transient response of the current density across a 60-nm-thick poly(3,4-ethylenedioxythiophene)/poly(styrene-sulfonate) film as a function of applied voltage during the pulse. The pulse duration is 10 ms, obtained using a voltage pulse generator with a rise time of 100 ns, limiting the current transient response observed at the onset of the pulse. The open arrow shows the plateau region where no changes in conductivity are observed; the filled arrow indicates the current peak corresponding to the process where there is a significant drop in conductivity, as is apparent from the slow drop in current density following the peak.

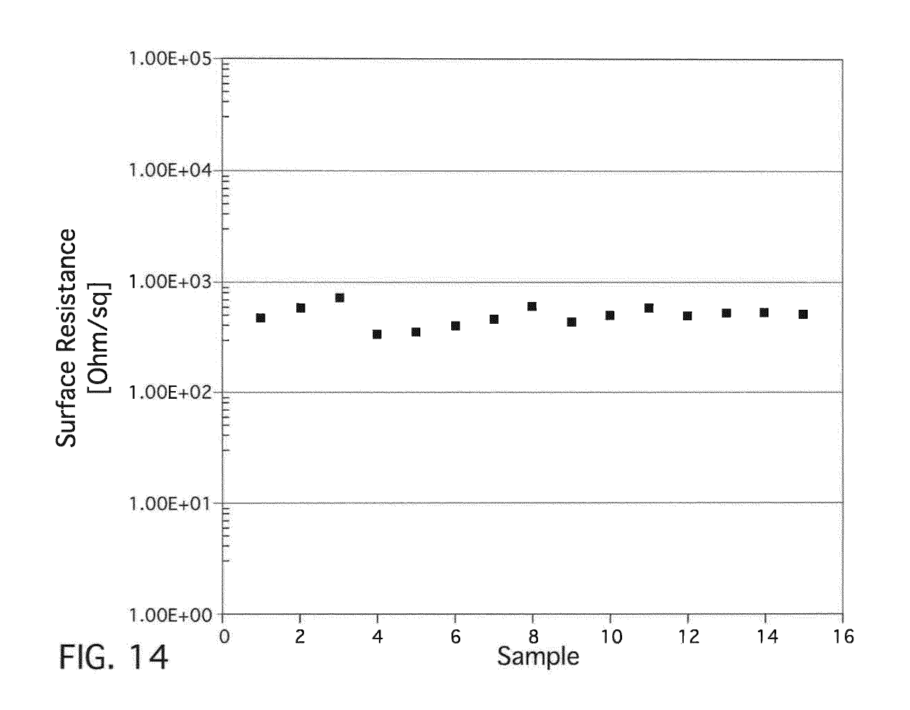

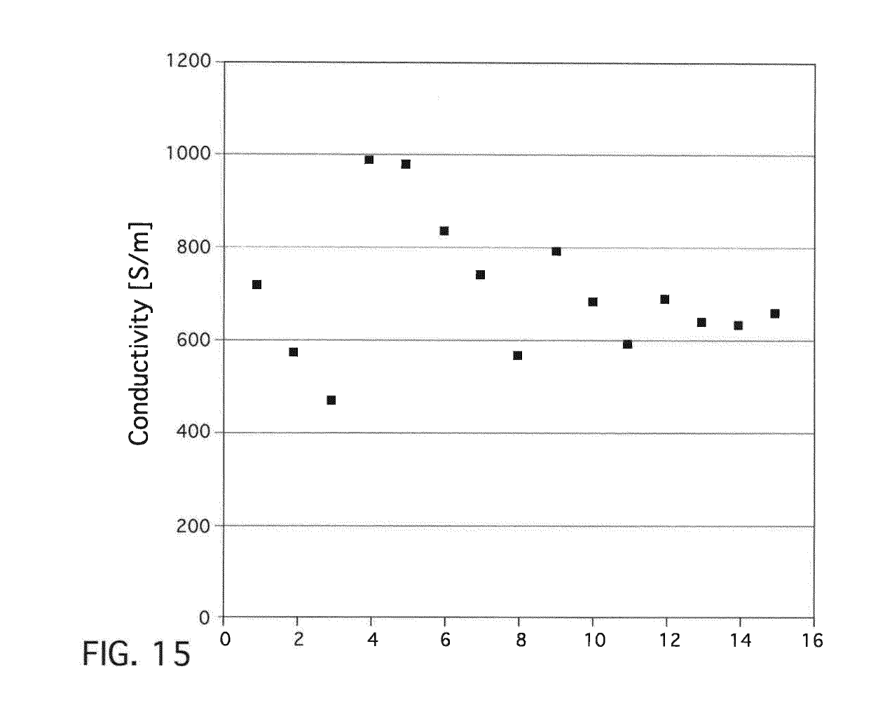

FIG. 14 shows the shows the surface resistance behavior of poly(3,4-ethylene-dioxythiophene)/poly(styrene-sulfonate) ink (ORGACON EL-P-3040) coated at 100 μm wet thickness on polyethylene terephthalate (PET). The conductivity behavior of the same conductive screen-printing ink coated at 100 μm wet thickness on polyethylene terephthalate is presented in FIG. 15.

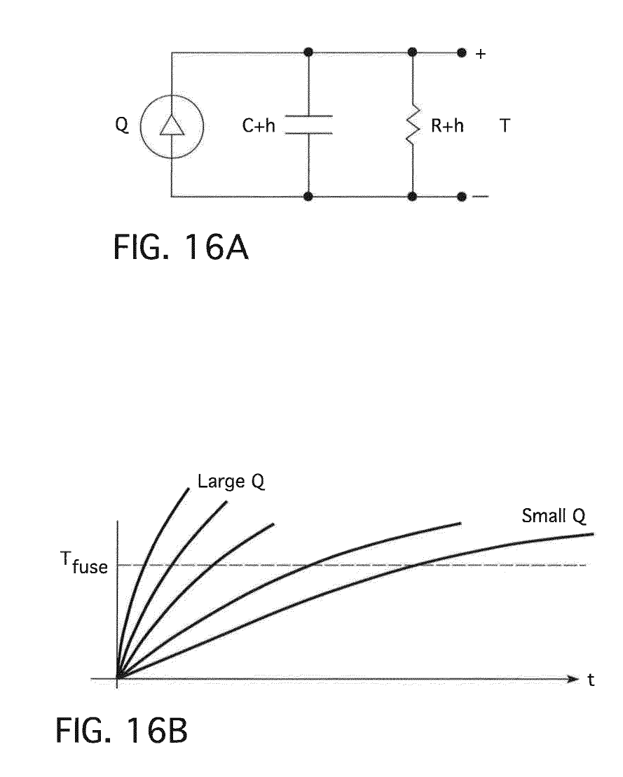

FIG. 16B shows the thermal model of a poly(3,4-ethylenedioxythiophene)/poly(styrene-sulfonate) fuse illustrated in FIG. 16A.

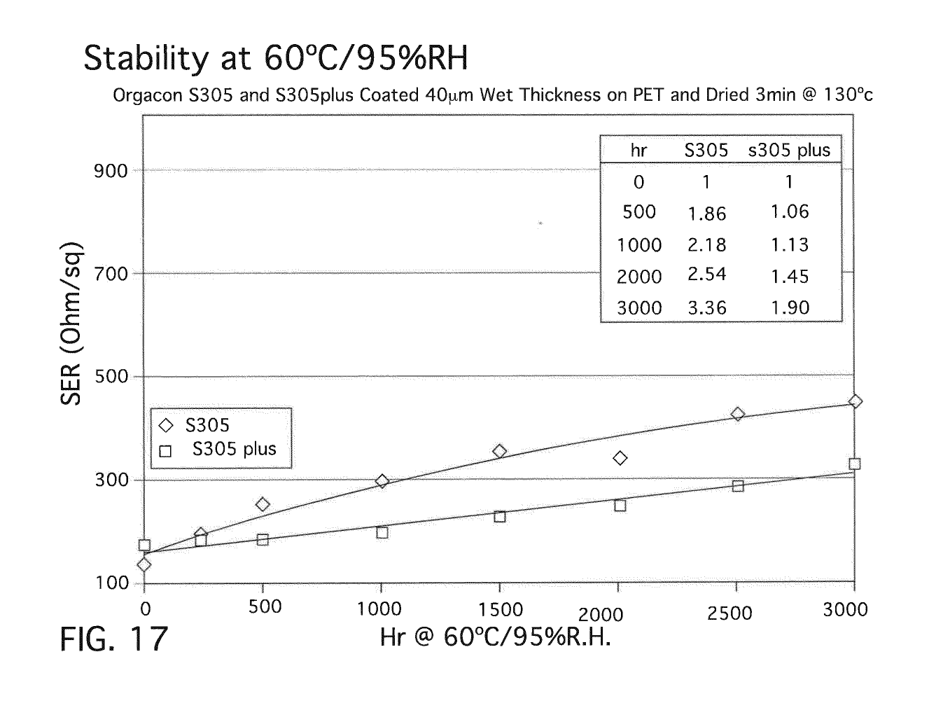

FIG. 17 shows the humidity and temperature stability of poly(3,4-ethylene-dioxythiophene)/poly(styrene-sulfonate) ink (ORGACON S305 and ORGACON S305plus) coated 40 μm wet thickness on polyethylene terephthalate and dried for three minutes at 130° C. As can be appreciated by reference to FIG. 17, elevated temperature and humidity gradually increase the resistivity of these commercially available poly(3,4-ethylenedioxy-thiophene)/poly(styrene-sulfonate) inks in a predictable way. This change in R_{elec} changes the time to blow (t_{blow}) according to equations given previously. Accordingly, over the life of a product, the fuse becomes more sensitive, so that smaller currents for smaller times can blow it. Conductive polymer fuses may preferably be printed with additional cross section (lower initial resistance) to account for this gradual increase in resistance.

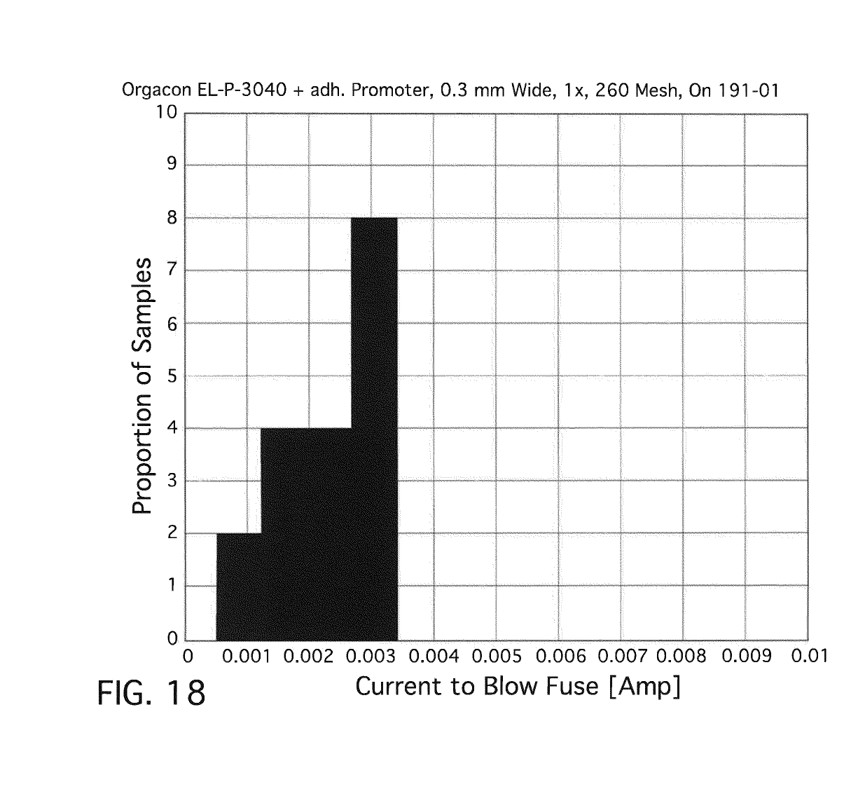

FIG. 18 shows that conductive polymer fuse printing was within print variation. The fuses were a copper:carbon grease: poly(3,4-ethylenedioxythiophene)/poly(styrene-sulfonate) connection. The number of samples n was 18; the median was 2.3 mA; the mean was 2.4 mA; the standard deviation was 0.8 mA; and the range was [0.5,3.5] mA (7× range).

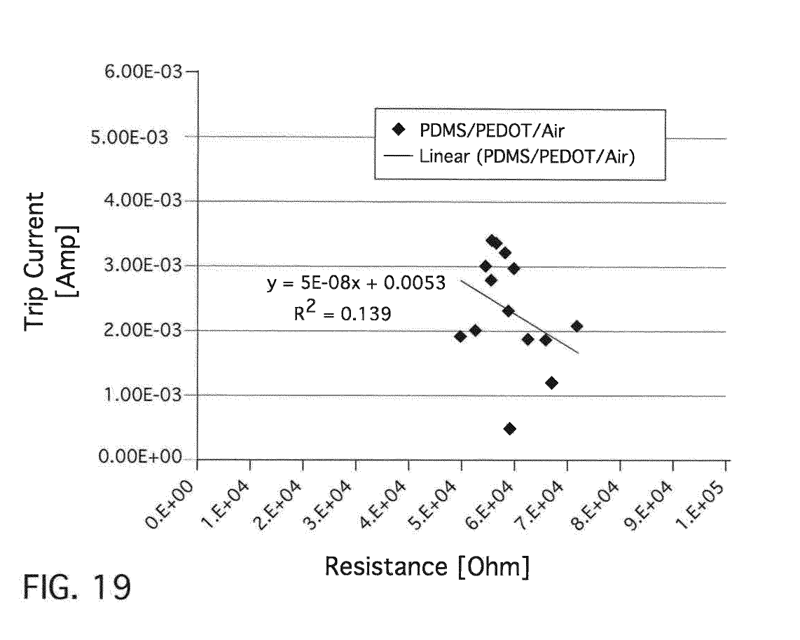

The data in FIG. 19 was used to determine whether poly(3,4-ethylenedioxy-thiophene)/poly(styrene-sulfonate) fuse resistance accounts for differences in trip current.
H0: β=0
H1: β<0 (one tailed test)

t=β/(s/sqrt(Sₓₓ))=2E−7, df=16.

Therefore, variations in fuse resistance did not explain the observed variation in trip current.

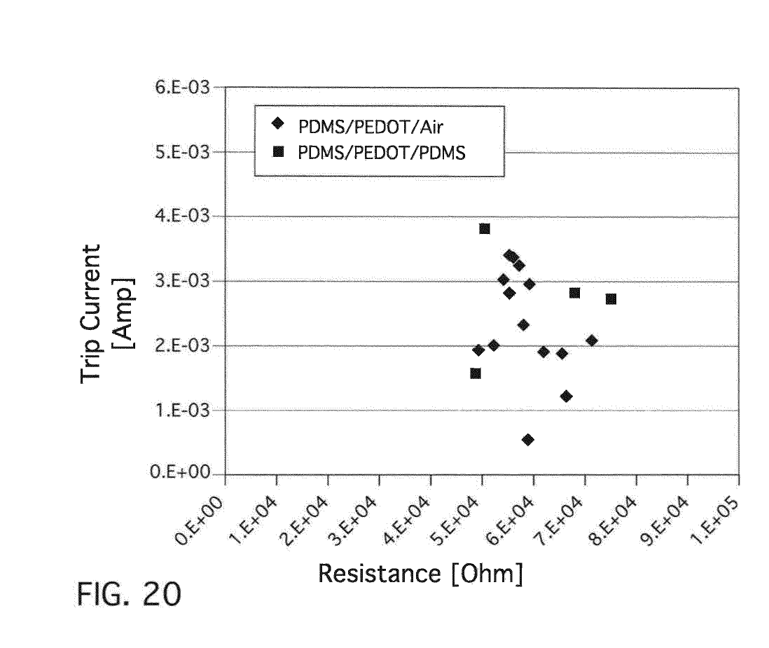

A determination of whether a poly(3,4-ethylenedioxythiophene)/poly(styrene-sulfonate) fuse works if it is placed under polydimethylsiloxane was made. Fuses that were 300 um wide of poly(3,4-ethylenedioxythiophene)/poly(styrene-sulfonate) ink (ORGACON EL-P-3040) were screen printed with one pass through a 260 mesh screenon polydimethylsiloxane (PDMS). Some of these fuses were subsequently coated with PDMS. As shown in FIG. 20, the conductive polymer fuse encapsulated with polydimethylsiloxane trips in a similar manner to that of a bare fuse. Thus, the present inventors concluded that direct atmospheric oxygen was not necessary for fuse operation, as the fuses work when encapsulated. Encapsulation is an important aspect of the fuses of the present invention, as encapsulation may protect the fuse from damage during assembly of an electroactive polymer actuator cartridge such as those depicted in FIGS. 2, 3 and 4. Suitable encapsulants include, but are not limited to, epoxy compounds, polyurethane compounds and silicone compounds.

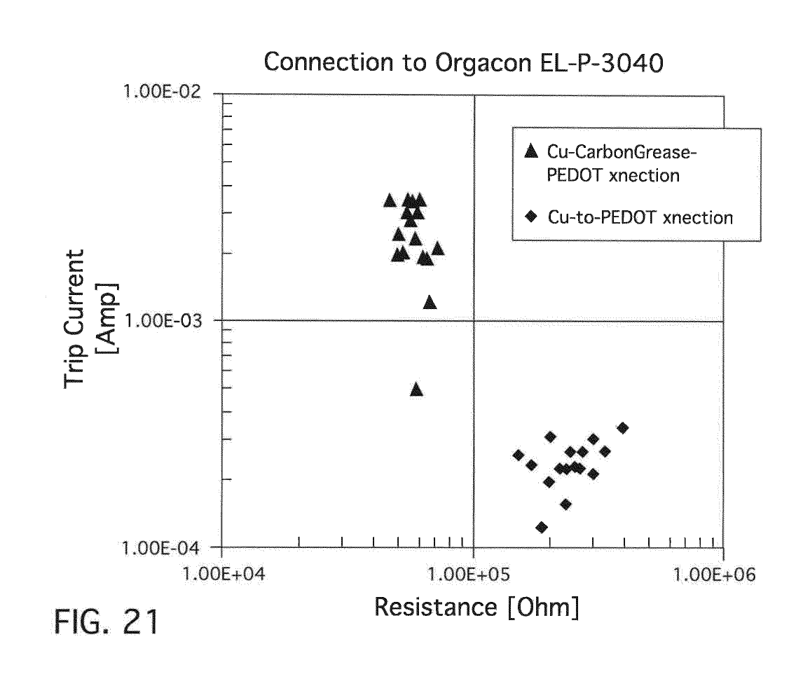

As can be appreciated by reference to FIG. 21, the copper: poly(3,4-ethylene-dioxythiophene)/poly(styrene-sulfonate) interface increased resistance approximately four times, and lowered trip current approximately ten times. Examples of conductive polymer fuses of the present invention used silver for the high conductivity connections because the inventors found silver gave the most repeatable trip current. Interfacial effects dominated the trip current of fuses connected to a circuit using some other common conductors (copper and carbon).

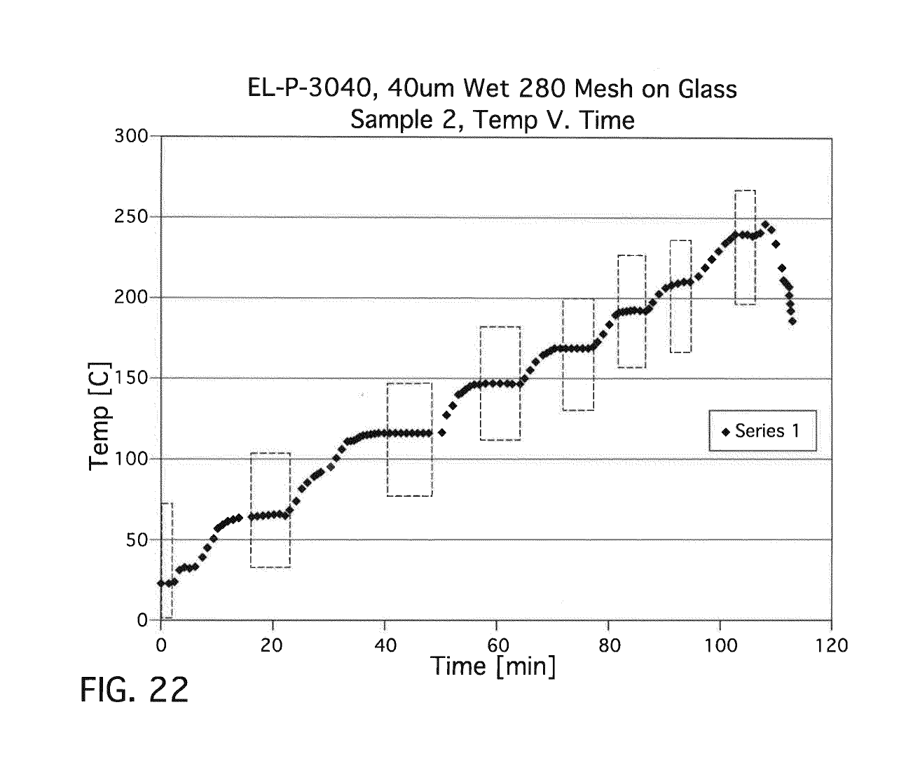

FIG. 22 shows the thermal and electrical properties of the poly(3,4-ethylene-dioxythiophene)/poly(styrene-sulfonate) screen-printing ink in air. A strip of ink was placed between copper leads. R was measured with a FLUKE 111 digital multimeter. The temperature was measured with an infra-red camera. Steady state data was used to generate the plot shown in FIG. 22.

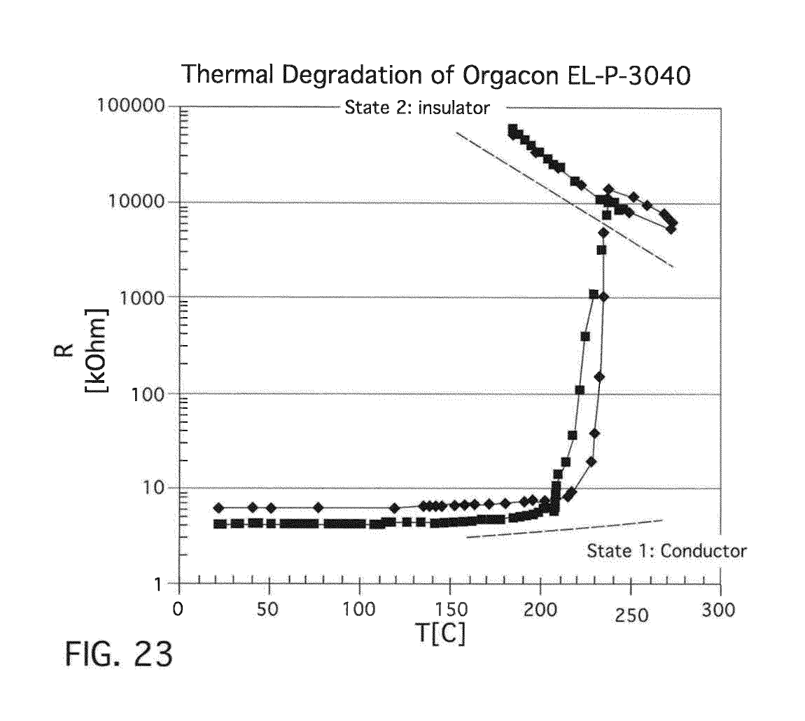

FIG. 23 illustrates the state change in poly(3,4-ethylenedioxythiophene)/poly(styrene-sulfonate) screen-printing ink. State 1 is characterized as having a temperature between 25-210° C., being conductive, having a positive temperature coefficient (↑T→↑R) and a transition at ˜210-240° C. State 2 is 1000 times more resistive and has a large negative temperature coefficient (↑T→↓R) and acts as an insulator.

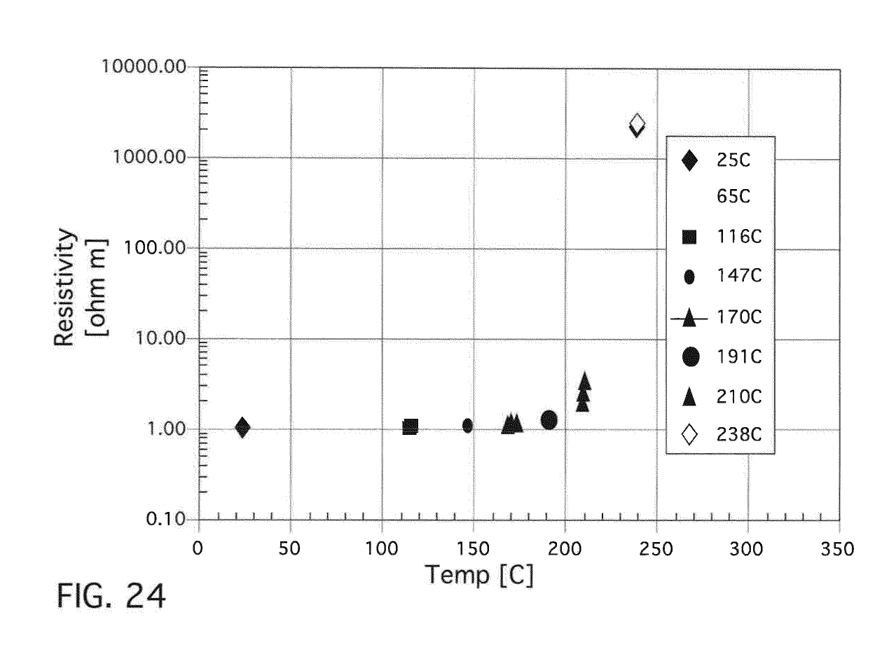

A plot of resistivity versus temperature for poly(3,4-ethylenedioxythiophene)/poly(styrene-sulfonate) screen-printing ink is provided in FIG. 24.

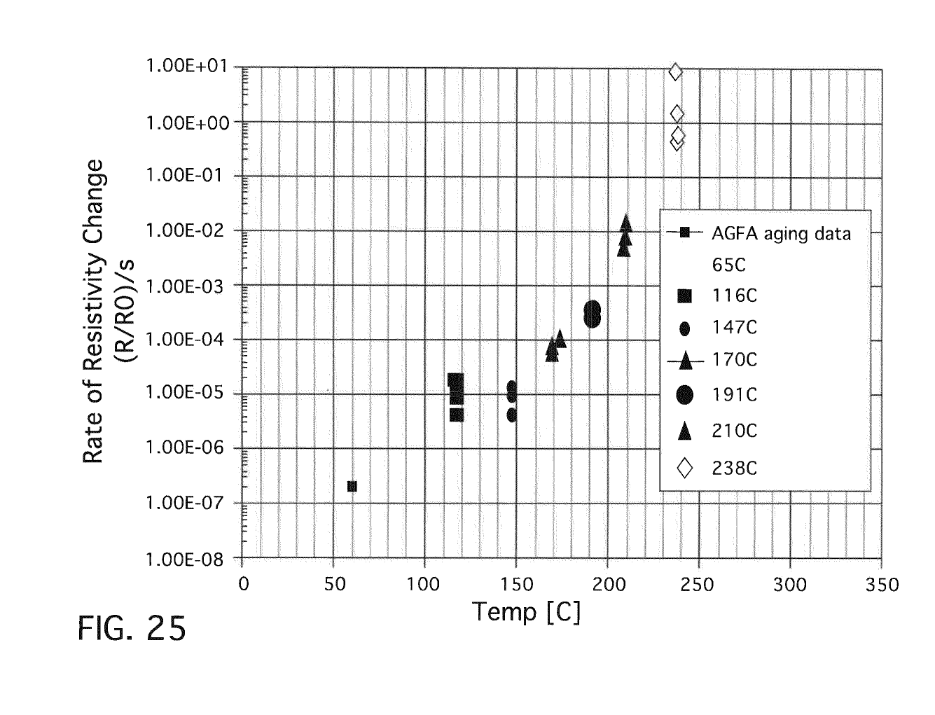

FIG. 25 illustrates the rate of thermal degradation of poly(3,4-ethylenedioxy-thiophene)/poly(styrene-sulfonate) screen-printing ink (ORGACON EL-P-3040). At 240° C., the resistivity increase was 1× to 10×/s.

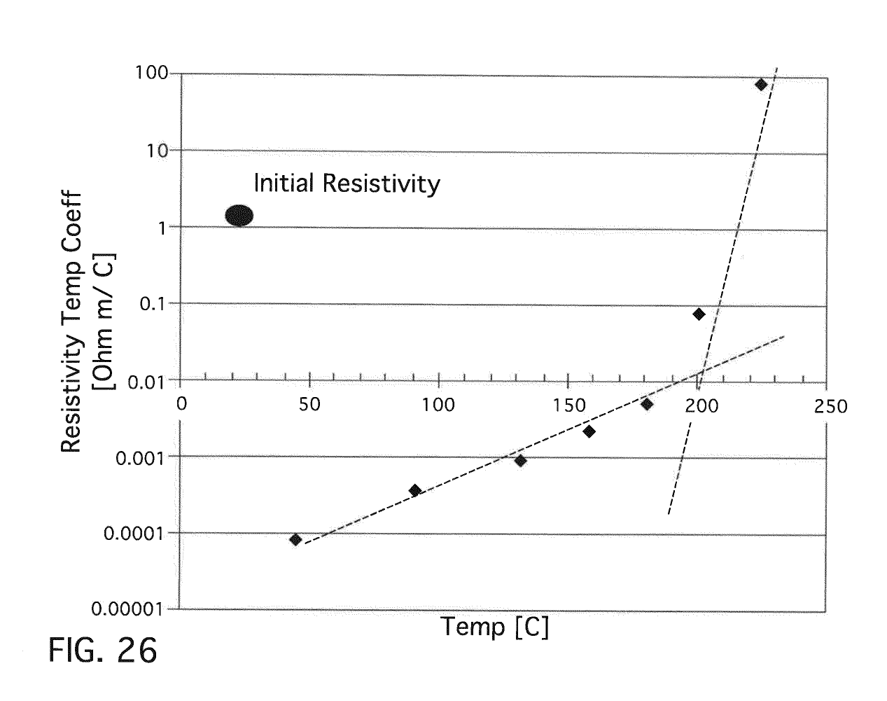

FIG. 26 shows the temperature coefficient in State 1 as depicted in FIG. 23. As can be appreciated by reference to FIG. 26, the coefficient is positive and described by a power law. The exponent qualitatively changes at about 200° C. Below this temperature, for example at 190° C., raising the temperature of the fuse one 5 degree Celsius only increased the electrical resistance by about one part in 100. Above this temperature, for example at 210° C., a one degree Celsius rise increased the resistance by a factor of about 100. Therefore, for electrically induced heating, the onset of thermal runaway is expected when part of the fuse reaches a temperature of about 200° C.

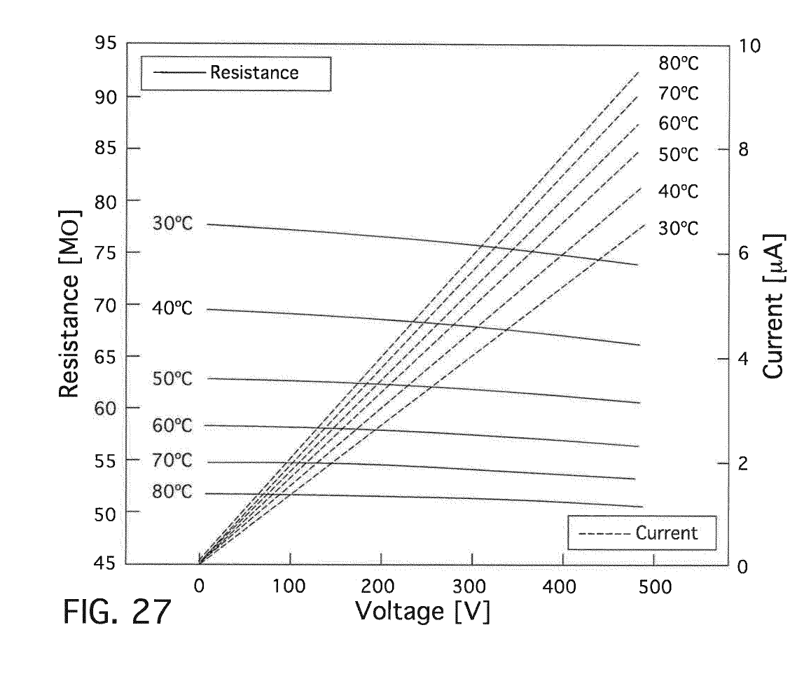

That poly(3,4-ethylenedioxythiophene)/poly(styrene-sulfonate) has desirable properties for a fuse as can be appreciated by reference to FIG. 27, according to the Master's thesis of Schweizer, (See, Schweizer-T M. “Electrical characterization and investigation of the piezoresistive effect of PEDOT:PSS thin films.” Master's Thesis, Georgia Institute of Technology (2005)). Below the transition temperature of ˜200° C., resistance drops with increasing temperature. This negative temperature coefficient keeps the fuse conducting, and inhibits thermal runaway when the circuit is working normally and currents are moderate. However, once the fuse reaches the transition temperature of ˜200° C. the temperature coefficient becomes markedly positive. Once oxidation starts (R increases) thermal runaway with transition to high resistance propagates along the fuse link. As those skilled in the art are aware, special alloys are typically used in metal fuses to achieve this behavior.

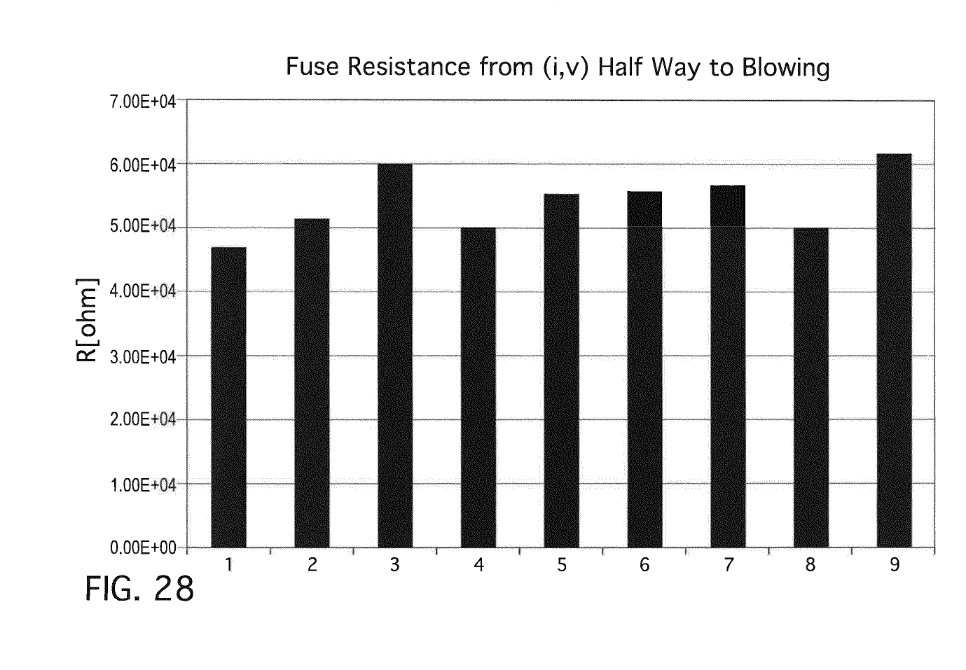

The resistance repeatability of inventive conductive polymer fuses is shown in FIG. 28.

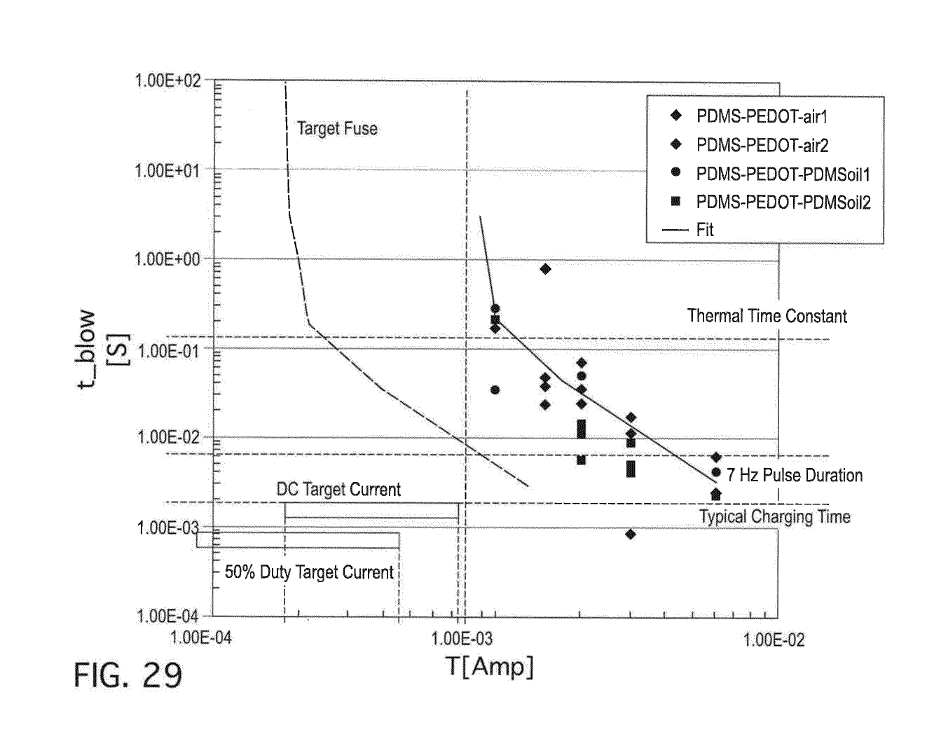

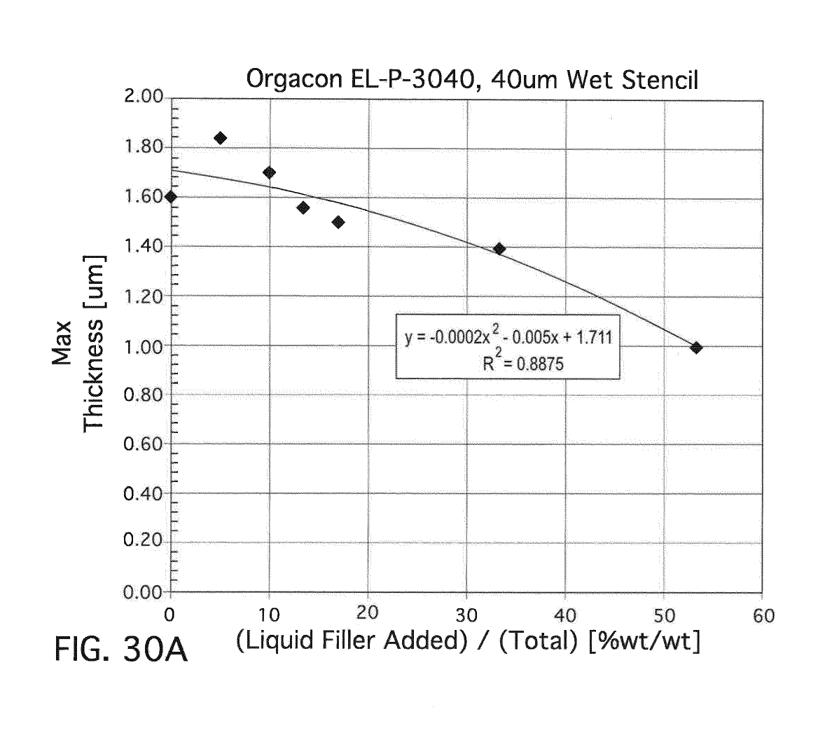

FIG. 29 presents the results from a first printing of poly(3,4-ethylenedioxy-thiophene)/poly(styrene-sulfonate) fuses—DC (i,t) characteristic, and target.

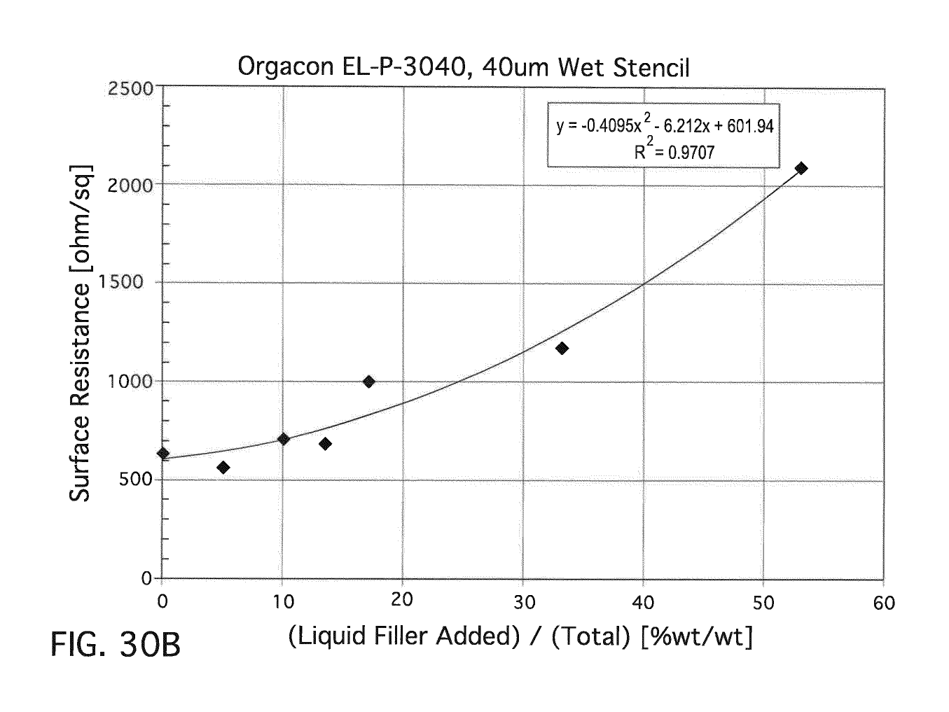

FIGS. 30A and 30B show adjusting the thickness and surface resistance of the conductive polymer fuse of the present invention with liquid filler. As can be appreciated by reference to FIGS. 30A and 30B, adding filler means decreased thickness, increased R_{surf} and a smaller thermal mass receives greater (i²R) power.

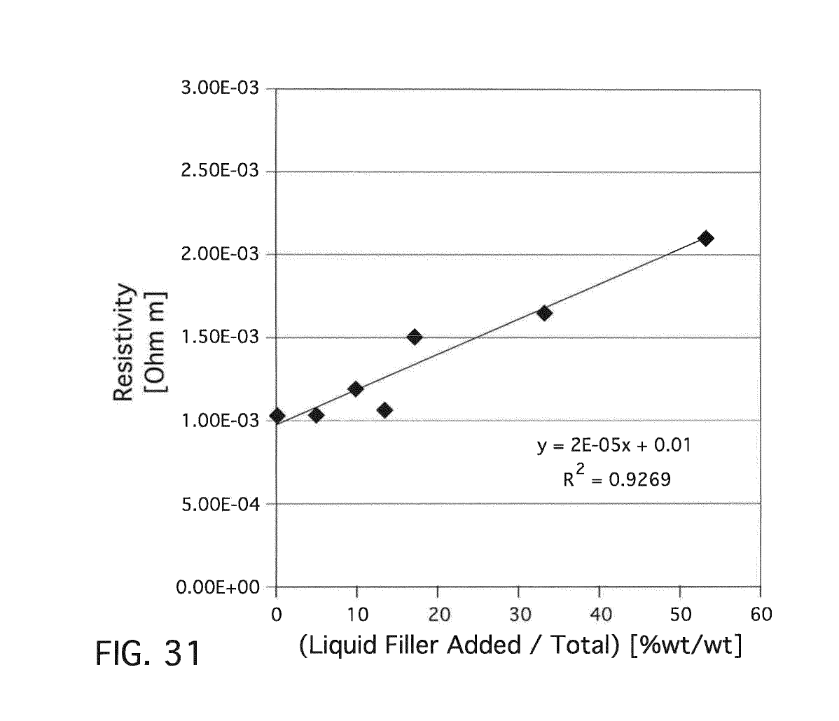

FIG. 31 illustrates effect of dilution on the resistivity of poly(3,4-ethylene-dioxythiophene)/poly(styrene-sulfonate) screen-printing ink. As can be appreciated by reference to FIG. 31, substantial quantities of filler (e.g. 50 wt %) must be added to a commercially available poly(3,4-ethylenedioxythiophene)/poly(styrene-sulfonate) ink in order to double the bulk resistivity of the fuse, indicating that the initial concentration of poly(3,4-ethylenedioxy-thiophene) particulates in the ink formulation is far above the percolation threshold.

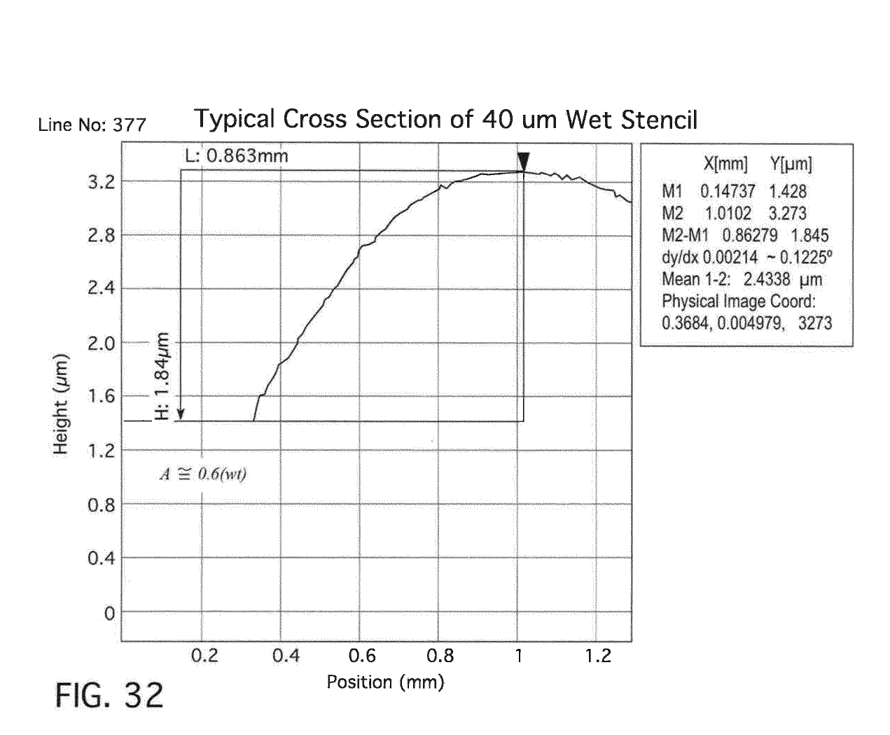

FIG. 32 shows a typical cross section of 40 μm wet stencil. As can be appreciated by reference to FIG. 32, the actual conducting cross section of a fuse is about 0.6(wt) where w is the width and t is the thickness, and the final thickness of the fuse is about one-twentieth of the thickness of the stencil, 1.84 μm.

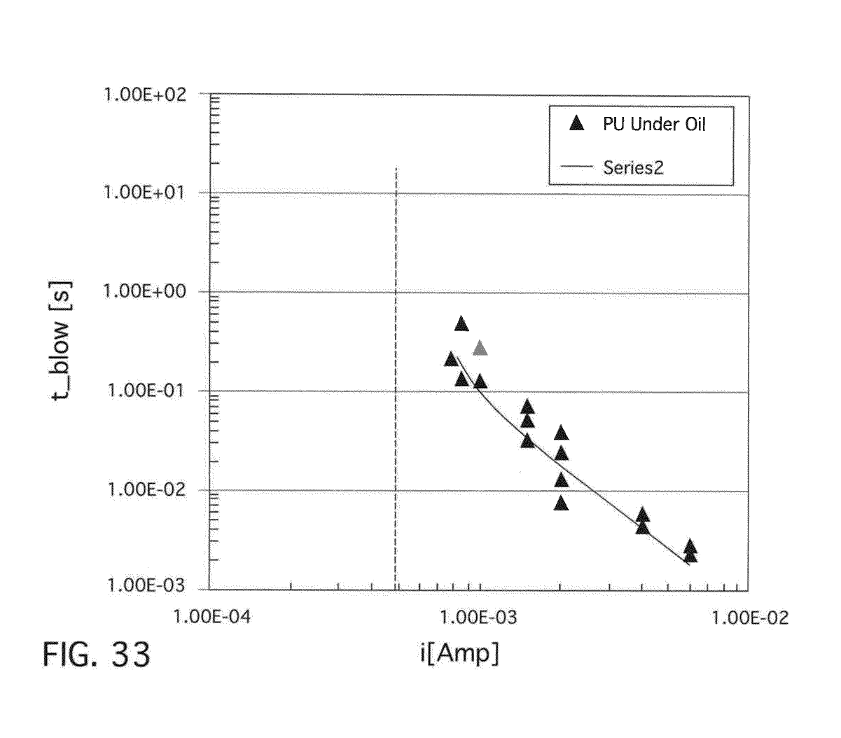

FIG. 33 illustrates poly(3,4-ethylenedioxythiophene)/poly(styrene-sulfonate) fuses on polyurethane under oil. As can be appreciated by reference to FIG. 33, poly(3,4-ethylenedioxy-thiophene)/poly(styrene-sulfonate) fuses printed on polyurethane are like poly(3,4-ethylenedioxy-thiophene)/poly(styrene-sulfonate) fuses printed on silicone: atmospheric oxygen is not required for operation.

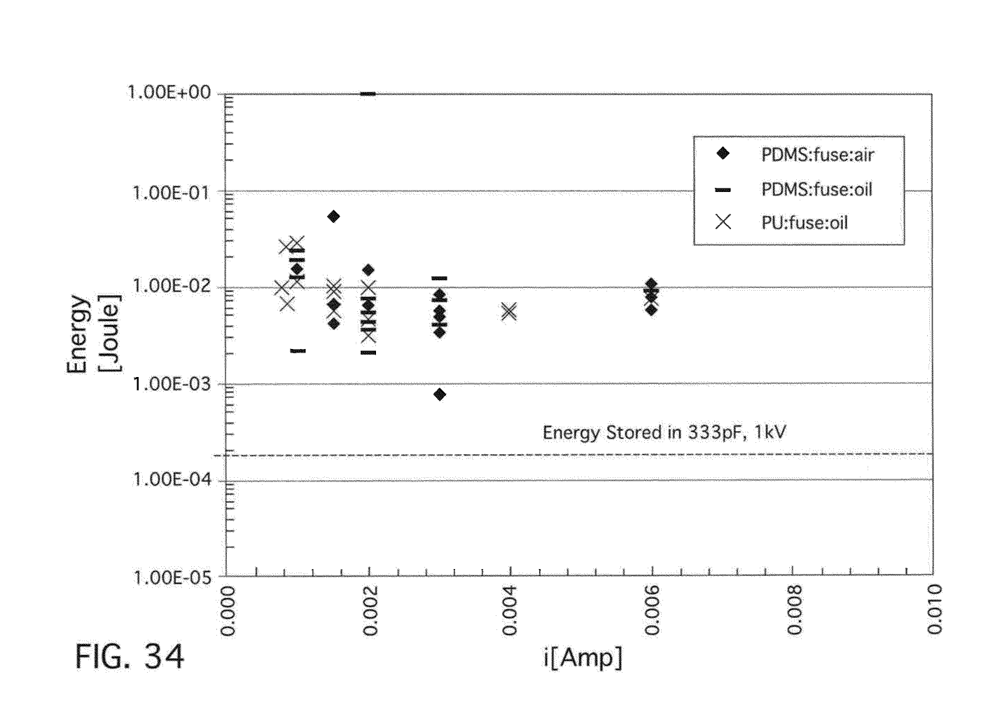

FIG. 34 shows the energy needed to start clearing of a poly(3,4-ethylenedioxy-thiophene)/poly(styrene-sulfonate) fuse. In the legend, PU refers to polyurethane and PDMS refers to polydimethylsiloxane. A similar energy is needed for all three situations as illustrated in FIG. 34. The energy is greater than the energy stored in one segment of a 3-bar electroactive polymer actuator, and so discharging a segment will not trip its fuse. This prevents a cascade of blown fuses. When there is an electrical fault in one segment, neighboring segments can transfer their stored charge to that segment without damaging their own fuses. The fuse of the faulty segment is tripped by the summed currents of several parallel strips, and by sustained action of the power supply.

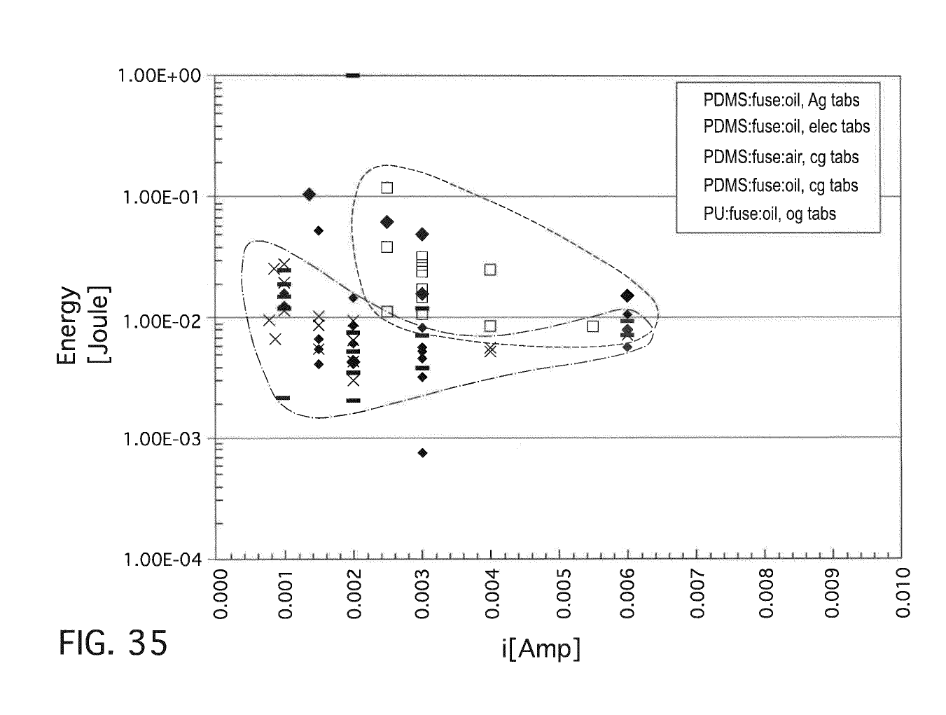

FIG. 35 shows the effect of an interface on the energy needed to start clearing of a poly(3,4-ethylenedioxythiophene)/poly(styrene-sulfonate) fuse. As can be appreciated from FIG. 35, the conductive polymer fuses with electrode and silver connections carry about three times more current, and absorb more energy before blowing.

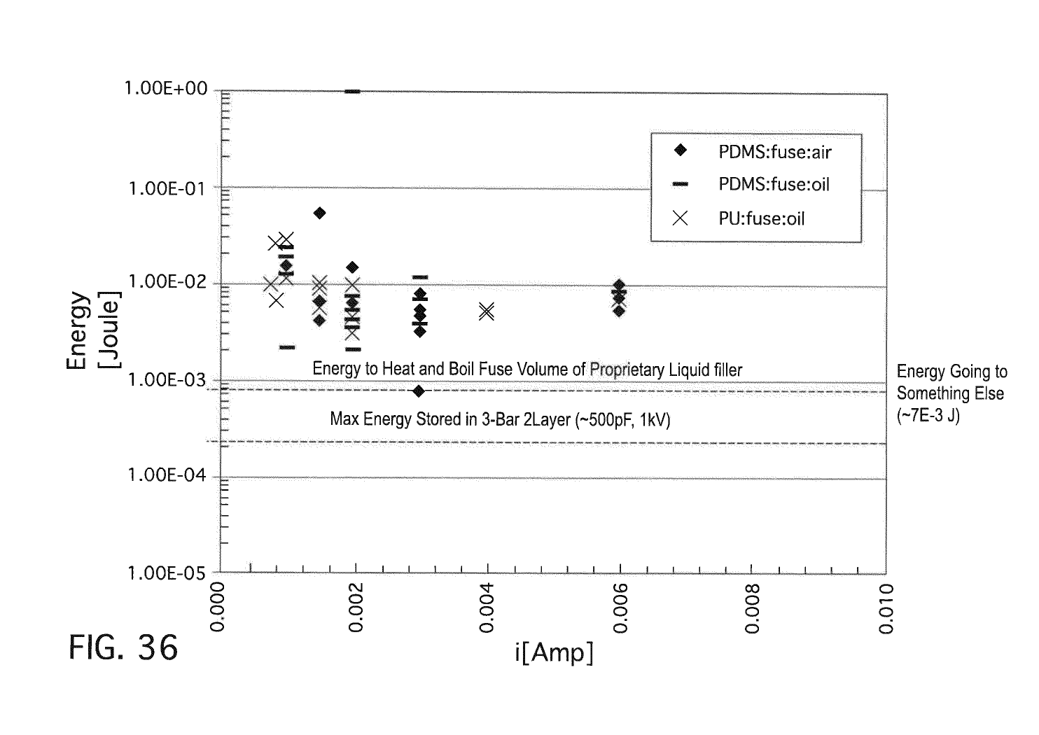

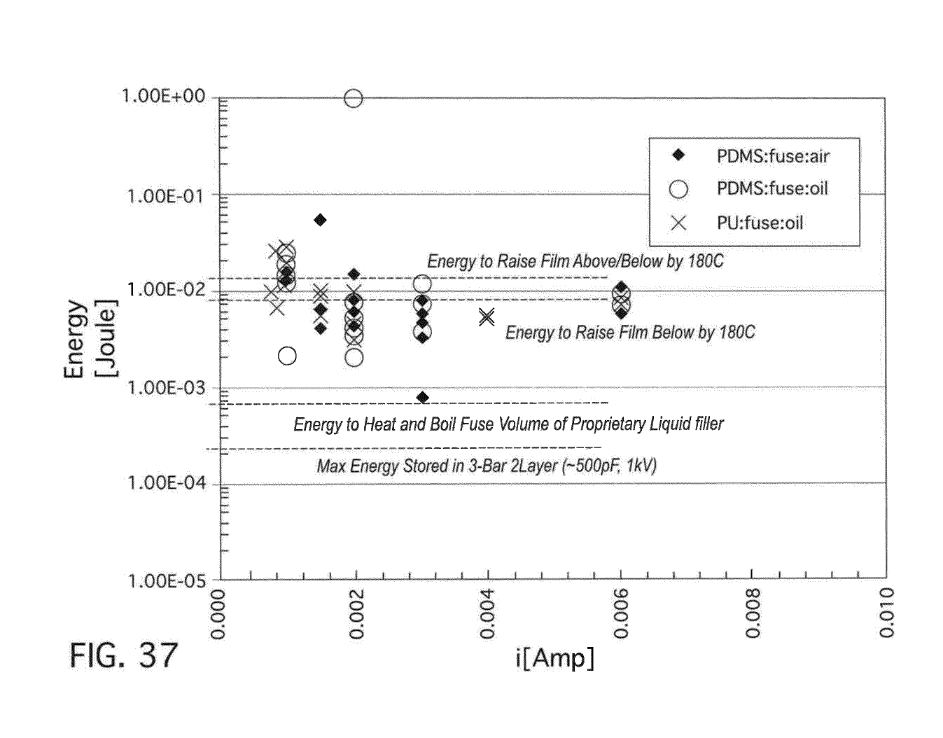

FIG. 36 shows that the energy required to boil a proprietary liquid filler out of the fuse is only 10% of the energy dissipated in tripping the fuse, and that 90% of the thermal energy goes somewhere else. FIG. 37 shows the results of finite element modeling of heat transfer from poly(3,4-ethylenedioxythiophene)/poly(styrene-sulfonate) fuse to film and air. Heat transfer to the film and air accounted for this missing 90% of heat energy.

For larger devices, the trip current of a fuse can be adjusted by changing the cross-section, but for small electroactive polymer actuators, there is a practical limit on this strategy. The current density that blows conductive screen-printing ink fuses is (J≈7E6 A/m²). The minimum printable cross-section is −3E-10 m², and this cross-section blows at −2 mA.

iₘᵢₙ=Jₜᵣᵢₚ/Aₘᵢₙ=(7E6 A/m²)/(3E−10 m²)=2E−3 A

When trip currents below this printing limit are desired, the material properties of the ink must be modified. For example, in some cases a 3-bar, 2 layer electroactive polymer actuator cartridge may require a DC trip current of 0.2 mA, 10-fold lower than this practical printing limit. In these cases, the poly(3,4-ethylenedioxy-thiophene)/poly(styrene-sulfonate) ink resistivity may be adjusted.

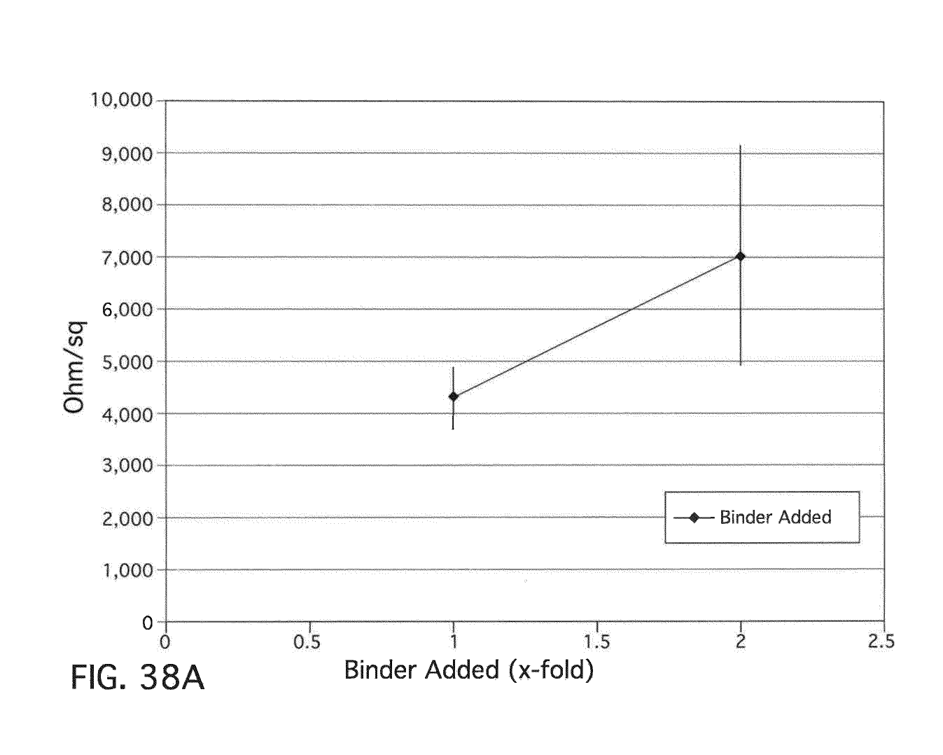

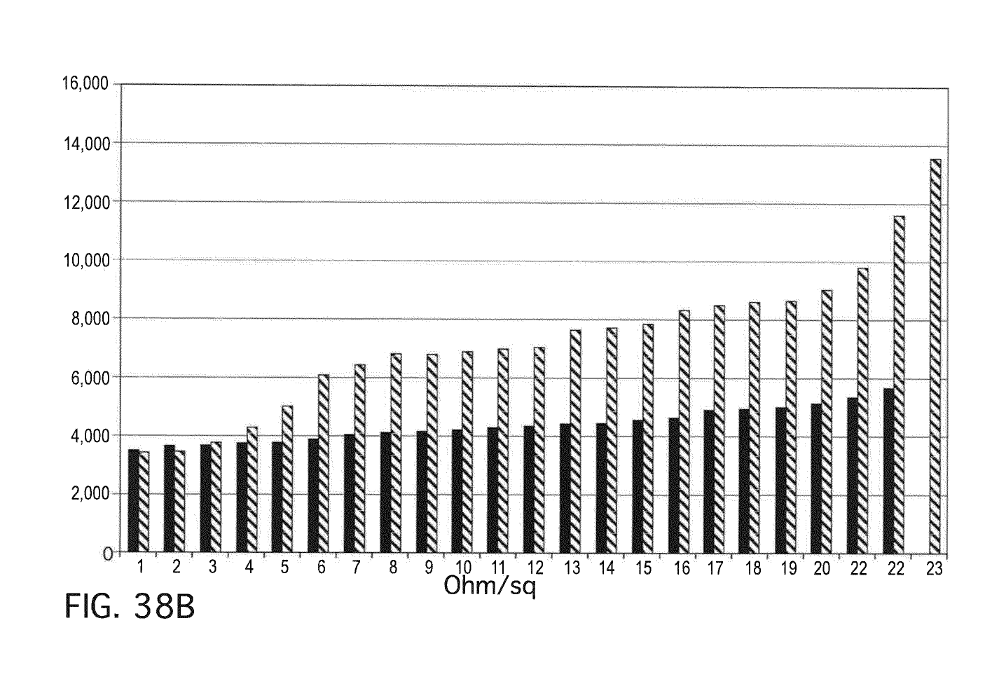

FIGS. 38A and 38B illustrate diluting poly(3,4-ethylenedioxythiophene)/poly(styrene-sulfonate) screen-printing ink with adhesion promoter (binder). As can be appreciated by reference to FIGS. 38A and 38B, doubling the binder roughly doubled the median resistivity. Some samples were just as conductive as un-diluted. The variability was far greater, and undesirable.

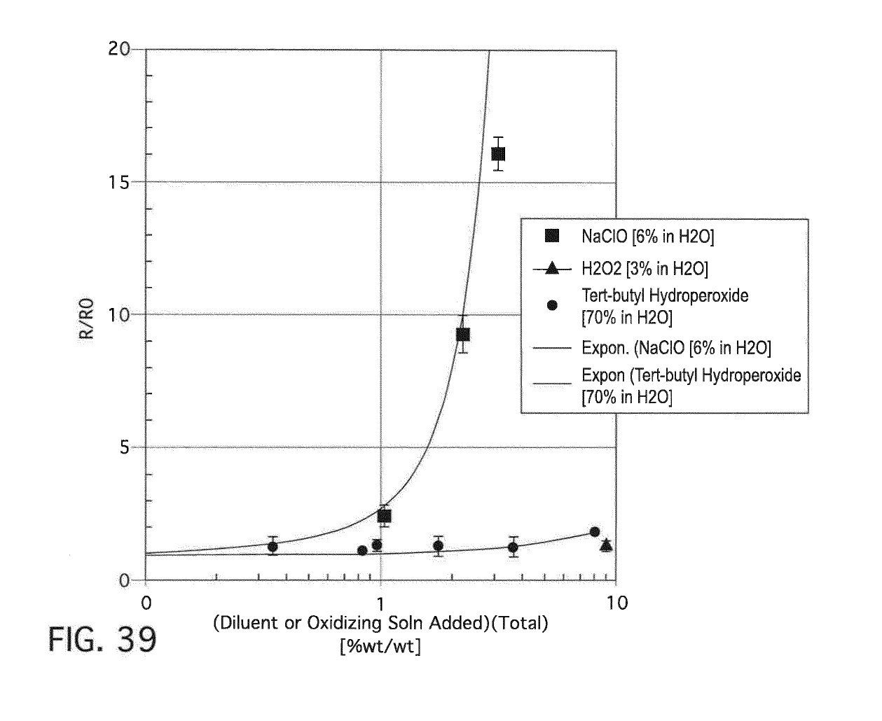

FIG. 39 shows how ink resistivity may be adjusted by adding oxidizers. As can be appreciated by reference to FIG. 39, sodium hypochlorite (NaClO) (6 wt % in water) effectively increases resistivity (2× at 1 wt %). The residual Na⁺, Cl⁻ in blown fuses may cause problems for the fuse to withstand problems in humidity. Two other oxidizers were less effective means of adjusting ink resistivity. To adjust the resistivity with off-the-shelf hydrogen peroxide (H₂O₂) (3 wt % in water) would require more than 10 vol %, which caused undesirable changes to the ink rheology. Another oxidizer, tert-butyl hydroperoxide (70 wt/in water) also provided relatively little effect (2× at 8 wt %).

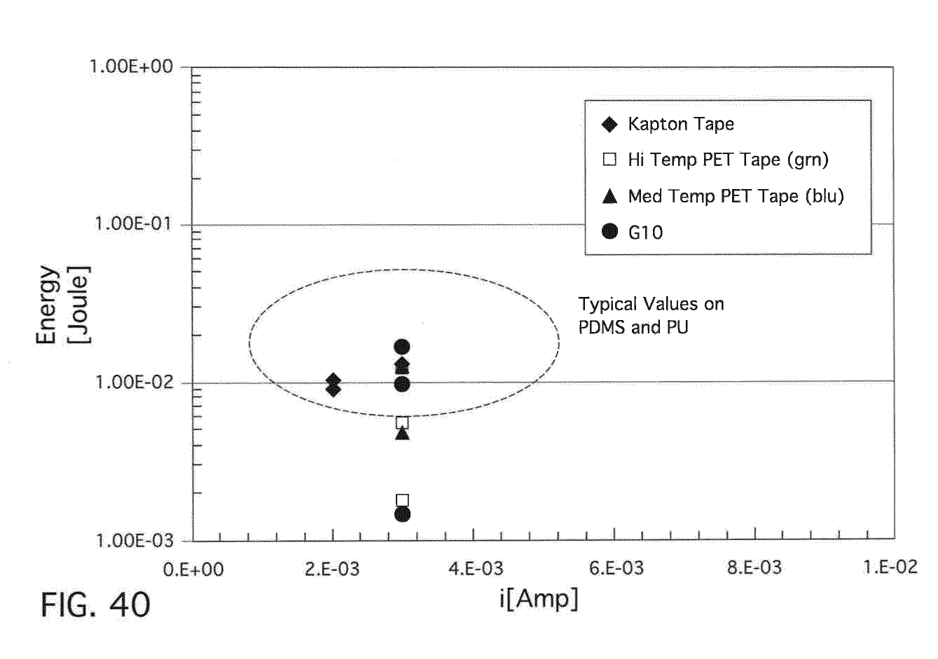

FIG. 40 illustrates poly(3,4-ethylenedioxythiophene)/poly(styrene-sulfonate) screen-printing ink fuses on different substrates. As can be appreciated by reference to FIG. 40, suitable substrates include polyimide film with silicone adhesive (KAPTON) tape, high temperature polyethylene terephthalate (PET) and medium temperature polyethylene terephthalate (PET). Epoxy laminates and films of silicone, polyurethane, and acrylates may also be suitable substrates.

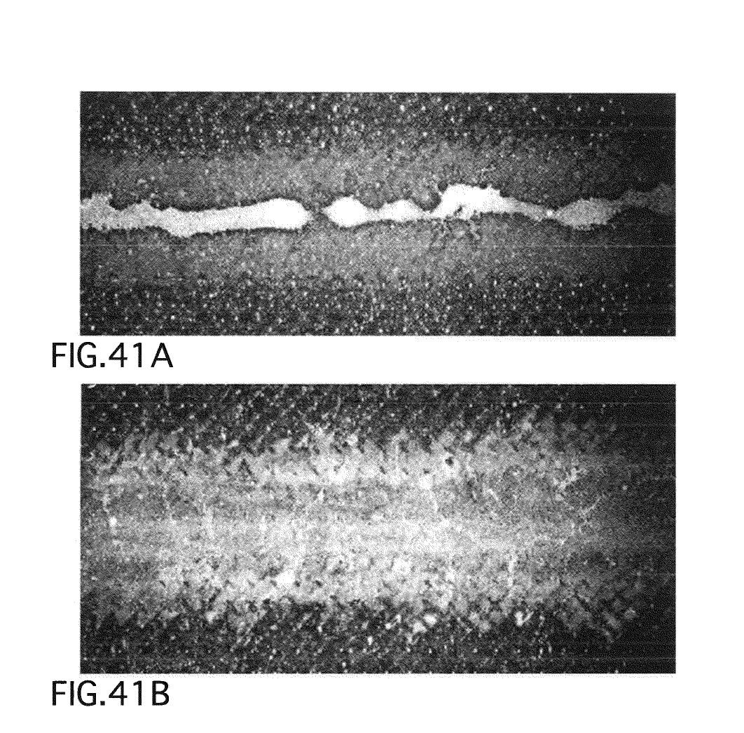

FIGS. 41A and 41B show wetting out of poly(3,4-ethylenedioxythiophene)/poly(styrene-sulfonate) screen-printing ink on polydimethylsiloxane, with and without an organosilane coupling agent. As can be appreciated by reference to FIGS. 41A and 41B, problems wetting of the ink may be improved by use of coupling agents.

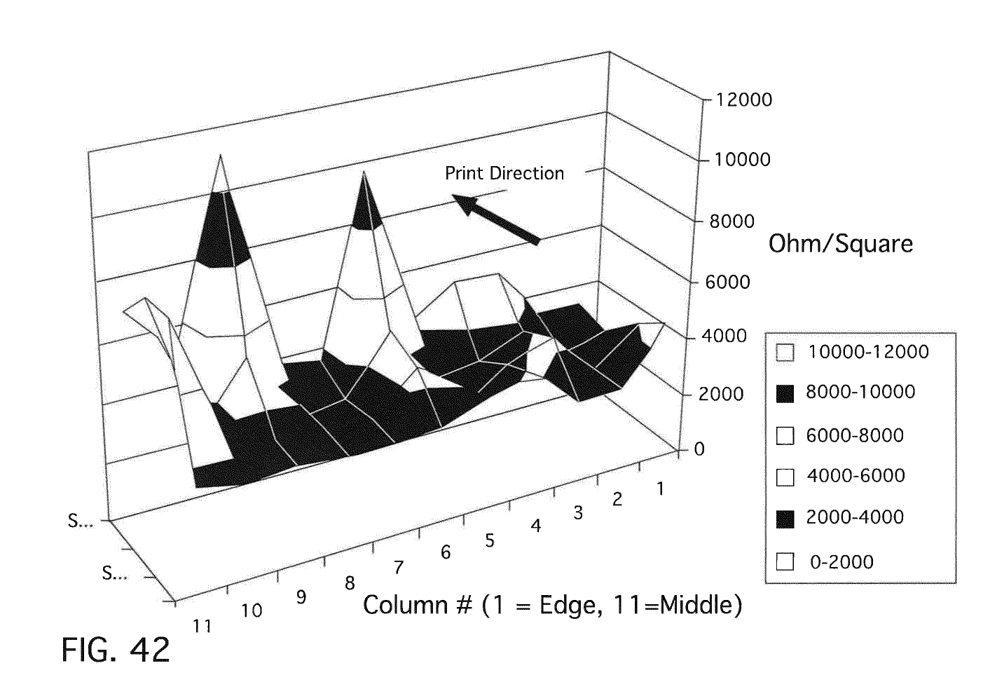

FIG. 42 illustrates printing uniformity. As can be appreciated by reference to FIG. 42, non-uniformity in a printing process may cause changes in fuse resistance. The higher resistance fuses in columns 5 and 9, for example, are consistent with uneven pressure applied by the squeegee of a screen printer. Accordingly, it is desirable to establish printing parameters that produce repeatable fuses.

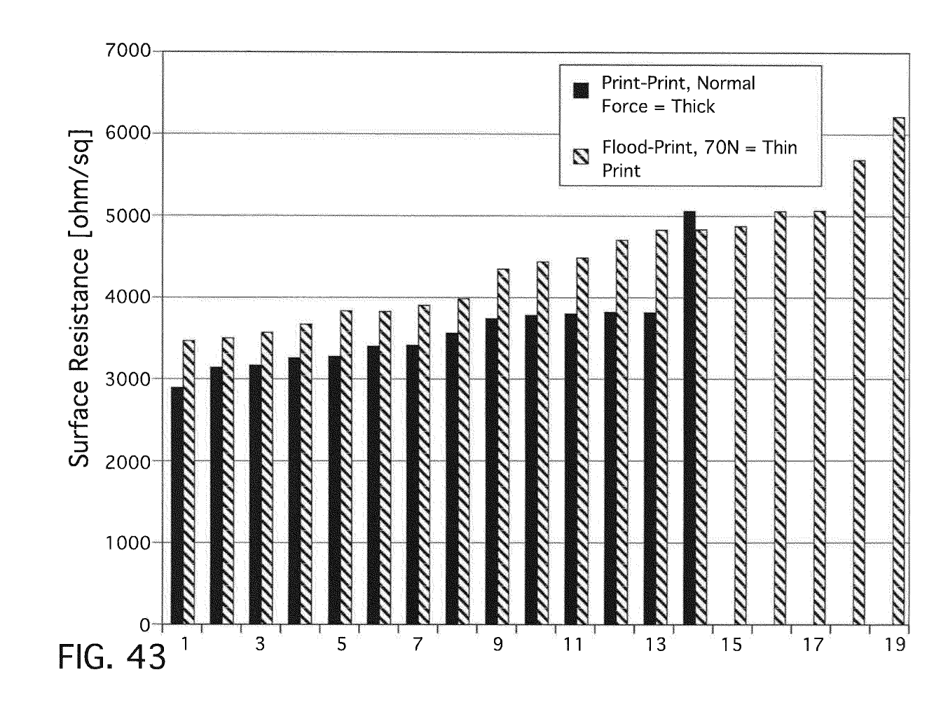

FIG. 43 shows printing conditions to vary fuse resistance. The present inventors noticed that printing conditions vary the fuse resistance by ˜20%.

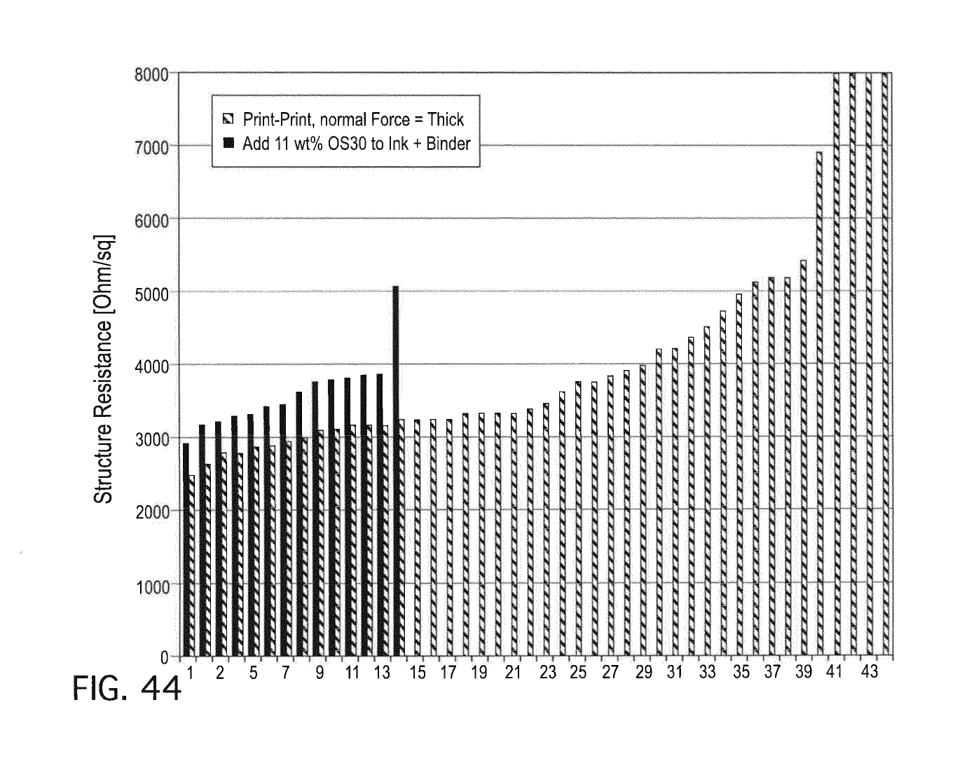

FIG. 44 illustrates volatile methylsiloxane diluent to vary conductive polymer fuse resistance. As can be appreciated by reference to FIG. 44, the diluent at 11% raised the resistance by about 20%, but also increased the fuse-to-fuse variance.

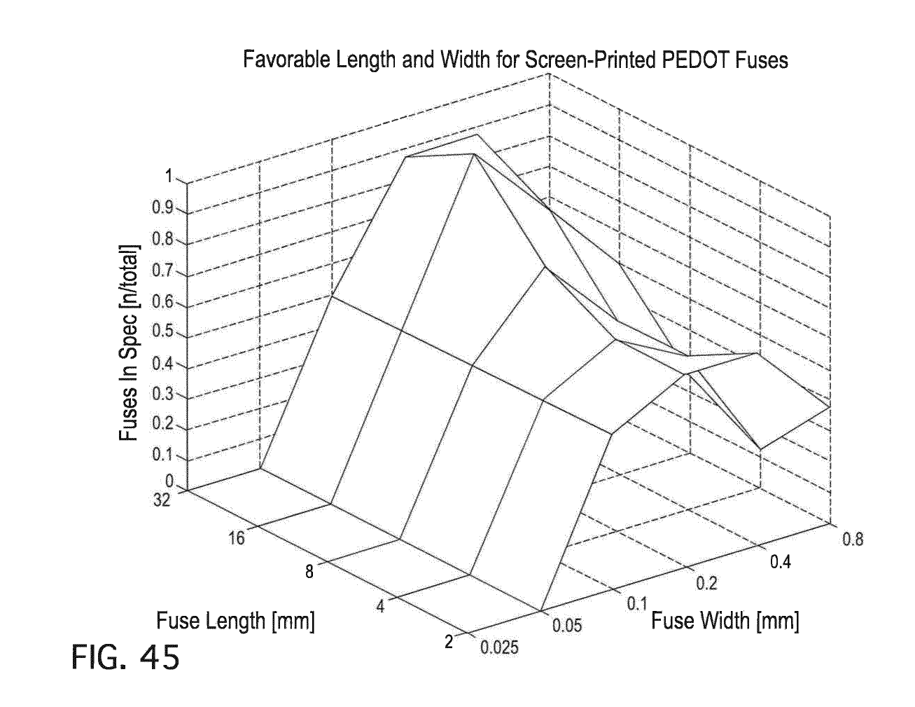

FIG. 45 shows favorable length and width for printing poly(3,4-ethylenediox-ythiophene)/poly(styrene-sulfonate) fuses.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A conductive polymer fuse comprising:
a substrate having printed thereon poly(3,4-ethylenedioxythiophene)/poly(styrene-sulfonate); and
one or more high conductivity connections,
wherein the conductive polymer fuse is encapsulated with an encapsulant.

2. The conductive polymer fuse according to claim 1, wherein the substrate is selected from the group consisting of polyimide film, high temperature polyethylene terephthalate film, medium temperature polyethylene terephthalate film, silicone film, polyurethane film, acrylate film, and epoxy laminate.

3. The conductive polymer fuse according to one of claims 1 and 2, wherein the encapsulant is selected from the group consisting of an epoxy compound, a polyurethane compound, and a silicone compound.

4. The conductive polymer fuse according to one of claims 1 to 3, wherein the high conductivity connections comprise silver or carbon.

5. A method of making the conductive polymer fuse according to one of claims 1 to 4 comprising:
printing a solution or a suspension of poly(3,4-ethylenedioxythiophene)/poly(styrene-sulfonate) on a substrate;
connecting the poly(3,4-ethylenedioxythiophene)/poly(styrene-sulfonate) via one or more high conductivity connections to an electrical bus; and
encapsulating the conductive polymer fuse with an encapsulant.

6. The method according to claim 5, wherein the step of printing is selected from the group consisting of screen printing, pad printing, ink jet printing, and aerosol jet printing.

7. The method according to one of claims 5 and 6, wherein the poly(3,4-ethylenedioxythiophene)/poly(styrene-sulfonate) is dissolved or suspended in a solvent system comprising water.

8. A method of protecting an electronic device from a short circuit comprising including in the device one or more conductive polymer fuses according to one of claims 1 to 7.

9. The method according to claim 8, wherein the at least one conductive polymer fuse is positioned to electrically isolate a failed segment of the electronic device and enable the continued operation of undamaged segments of the electronic device.

10. The method according to one of claims 8 and 9, wherein the electronic device is an electroactive polymer device.

11. The method according to claim 10, wherein the conductive polymer fuse is located in a passive region of the electroactive polymer device.
